(19) United States
(12) Patent Application Publication
(10) Pub. No.: US 2025/0314736 A1
(43) Pub. Date: Oct. 9, 2025

(54) SIGNALING TECHNIQUES FOR RECEIVED SIGNAL TIME DIFFERENCE MEASUREMENTS

(71) Applicant: QUALCOMM Incorporated, San Diego, CA (US)

(72) Inventors: Harikumar KRISHNAMURTHY, San Diego, CA (US); Sven FISCHER, Nuremberg (DE); Alexandros MANOLAKOS, Athens (GR); Alberto RICO ALVARINO, San Diego, CA (US); Chiranjib SAHA, Lakeside, CA (US)

(21) Appl. No.: 18/863,532

(22) PCT Filed: Jul. 18, 2023
(86) PCT No.: PCT/US2023/027995

§ 371 Date: Nov. 6, 2024

(30) Foreign Application Priority Data
Aug. 2, 2022 (GR) 20220100631

(51) Int. Cl. G01S 5/02; G01S 5/14; H04W 64/00

(52) U.S. Cl. CPC G01S 5/0236; G01S 5/14; H04W 64/00

(57) ABSTRACT

Techniques are provided for determining a positioning reference signal (PRS) search window to enable positioning of a wireless node. An example method for determining a positioning reference signal search window includes receiving assistance data including search window subframe offset information, receiving a first positioning reference signal at a first time, determining a search window for a second positioning reference signal based at least in part on the first time and the search window subframe offset information, and receiving the second positioning reference signal at a second time, wherein the second time is proximate to the search window.

### CROSS-REFERENCE TO RELATED APPLICATION

This application claims the benefit of Greek Patent Application No. 20220100631, filed Aug. 2, 2022, entitled “SIGNALING TECHNIQUES FOR RECEIVED SIGNAL TIME DIFFERENCE MEASUREMENTS,” which is assigned to the assignee hereof, and the entire contents of which are hereby incorporated herein by reference for all purposes.

### BACKGROUND

Wireless communication systems have developed through various generations, including a first-generation analog wireless phone service (1G), a second-generation (2G) digital wireless phone service (including interim 2.5G and 2.75G networks), a third-generation (3G) high speed data, Internet-capable wireless service, a fourth-generation (4G) service (e.g., Long Term Evolution (LTE) or WiMax), and a fifth-generation (5G) service (e.g., 5G New Radio (NR)). There are presently many different types of wireless communication systems in use, including Cellular and Personal Communications Service (PCS) systems. Examples of known cellular systems include the cellular Analog Advanced Mobile Phone System (AMPS), and digital cellular systems based on Code Division Multiple Access (CDMA), Frequency Division Multiple Access (FDMA), Time Division Multiple Access (TDMA), the Global System for Mobile access (GSM) variation of TDMA, etc.

It is often desirable to know the location of a user equipment (UE), e.g., a cellular phone, with the terms “location” and “position” being synonymous and used interchangeably herein. A location services (LCS) client may desire to know the location of the UE and may communicate with a location center in order to request the location of the UE. The location center and the UE may exchange messages, as appropriate, to obtain a location estimate for the UE. The location center may return the location estimate to the LCS client, e.g., for use in one or more applications.

Obtaining the location of a mobile device that is accessing a wireless network may be useful for many applications including, for example, emergency calls, personal navigation, asset tracking, locating a friend or family member, etc. Existing positioning methods include methods based on measuring radio signals transmitted from a variety of devices including satellite vehicles and terrestrial radio sources in a wireless network such as base stations and access points. Further, the capabilities of UE's may vary and positioning methods may be based on the capabilities of the devices. The accuracy of a location estimate of a UE may be impacted by the assistance data provided by the network.

### SUMMARY

An example method for determining a positioning reference signal search window according to the disclosure includes receiving assistance data including an integer value associated with signals transmitted from a first station and a second station, wherein the signals include similar timing indications and the integer value represents a nearest time difference between a first timing indication transmitted by the first station and a similar second timing indication transmitted by the second station, receiving a first positioning reference signal at a first time, wherein the first positioning reference signal is transmitted by the first station, determining a search window for a second positioning reference signal based at least in part on the first time and the integer value, and receiving the second positioning reference signal from the second station at a second time, wherein the second time is proximate to the search window.

An example method for determining a positioning reference signal search window according to the disclosure includes receiving assistance data including a subframe offset value associated with signals transmitted from a first station and a second station, wherein the signals are organized into a plurality of subframes in a time domain and the subframe offset value represents a multiple of a half subframe, receiving a first positioning reference signal at a first time, wherein the first positioning reference signal is transmitted by the first station, determining a search window for a second positioning reference signal based at least in part on the first time and the subframe offset value, and receiving the second positioning reference signal from the second station at a second time, wherein the second time is proximate to the search window.

An example method for determining a positioning reference signal search window according to the disclosure includes receiving assistance data including search window subframe offset information, receiving a first positioning reference signal at a first time, determining a search window for a second positioning reference signal based at least in part on the first time and the search window subframe offset information, and receiving the second positioning reference signal at a second time, wherein the second time is proximate to the search window.

Items and/or techniques described herein may provide one or more of the following capabilities, as well as other capabilities not mentioned. A mobile device, such as user equipment (UE), may receive assistance data associated with reference signals transmitted by reference and neighboring stations. The mobile device may be configured to obtain time difference measurements based on the reference signals. The offsets between reference signals must be determined to utilize the time difference measurements for positioning applications. The assistance data may include one or more information elements to define offsets. A search window for detecting a reference signal transmitted by a neighboring station may be determined based on the timing of a reference signal transmitted by the reference station and the offset information. The time to detect a reference signal transmitted by neighboring stations may be reduced. The accuracy of position estimates may be increased. Other capabilities may be provided and not every implementation according to the disclosure must provide any, let alone all, of the capabilities discussed.

### BRIEF DESCRIPTION OF THE DRAWINGS

FIG. 1 is a simplified diagram of an example wireless communications system.

FIG. 2 is a block diagram of components of an example user equipment.

FIG. 3 is a block diagram of components of an example transmission/reception point.

FIG. 4 is a block diagram of components of an example server.

FIG. 5A is an example technique for determining a position of a mobile device using information obtained from a plurality of base stations.

FIG. 5B includes diagrams of example reference signal time differences (RSTDs) based on signals transmitted from two base stations.

FIGS. 6A and 6B. illustrate example downlink positioning reference signal resource sets.

FIG. 7 is an illustration of example subframe formats for positioning reference signal transmissions.

FIG. 8 is an illustration of example radio frequency signal transmissions organized into a plurality of subframes in the time domain.

FIG. 9 is a diagram of an example positioning reference signal search window.

FIGS. 10A-10C include diagrams of example use cases for determining a positioning reference signal search window.

FIG. 11 is a diagram of an example subframe offset value used for user equipment based positioning computations.

FIG. 12 is a diagram of an example technique for determining a search window when a large reference signal time difference is detected.

FIG. 13 is a block flow diagram of a first example method for determining a positioning reference signal search window.

FIG. 14 is a block flow diagram of a second example method for determining a positioning reference signal search window.

FIG. 15 is a block flow diagram of a third example method for determining a positioning reference signal search window.

### DETAILED DESCRIPTION

Techniques are discussed herein for determining a positioning reference signal (PRS) search window to enable positioning of a wireless node. A network positioning session may utilize reference signal measurements obtained by wireless nodes such as mobile devices (e.g., user equipment (UE)) and base stations to determine a position estimate for a wireless node. A network may provide assistance data (AD) and downlink positioning reference signals (DL PRS) to enable mobile devices to determine a position. The timing of the DL PRS transmissions may vary and the AD may include timing information such as frame, subframe and slot information to enable a mobile device to accurately compensate for the variations in DL PRS transmit times. In an example, the AD may also be utilized to compute a search window to enable a mobile device to efficiently detect and decode DL PRS transmitted by neighboring stations. Existing assistance data messages may create ambiguity in generating an accurate search window for certain transmission timing offsets. For example, subframe offset values may be used to enable a mobile device to determine transmission time differences between DL PRS transmitted by a reference station and DL PRS transmitted by a neighboring station. Current subframe offset values, however, utilize an integer value which is rounded down to a multiple of the subframe to express the time difference between signals transmitted by the reference and neighbor stations. This integer value can create errors in computing a search window for detecting the DL PRS transmitted by the neighboring station. The techniques provided herein correct the deficiencies of the prior messaging. For example, the subframe offset value may be rounded to the nearest multiple of the subframe for computing the search window, and the positioning computations may be adjusted based on whether the integer was rounded up or down. In an example, the subframe offset value may be rounded down to the nearest multiple of a half subframe for computing the search window. In an example, the AD may include a new field to indicate a subframe offset for computing the search window. These techniques and configurations are examples, and other techniques and configurations may be used.

The description may refer to sequences of actions to be performed, for example, by elements of a computing device. Various actions described herein can be performed by specific circuits (e.g., an application specific integrated circuit (ASIC)), by program instructions being executed by one or more processors, or by a combination of both. Sequences of actions described herein may be embodied within a non-transitory computer-readable medium having stored thereon a corresponding set of computer instructions that upon execution would cause an associated processor to perform the functionality described herein. Thus, the various aspects described herein may be embodied in a number of different forms, all of which are within the scope of the disclosure, including claimed subject matter.

As used herein, the terms “user equipment” (UE) and “base station” are not specific to or otherwise limited to any particular Radio Access Technology (RAT), unless otherwise noted. In general, such UEs may be any wireless communication device (e.g., a mobile phone, router, tablet computer, laptop computer, consumer asset tracking device, Internet of Things (IoT) device, etc.) used by a user to communicate over a wireless communications network. A UE may be mobile or may (e.g., at certain times) be stationary, and may communicate with a Radio Access Network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or UT, a “mobile terminal,” a “mobile station,” a “mobile device,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, WiFi networks (e.g., based on IEEE 802.11, etc.) and so on.

A base station may operate according to one of several RATs in communication with UEs depending on the network in which it is deployed. Examples of a base station include an Access Point (AP), a Network Node, a NodeB, an evolved NodeB (eNB), or a general Node B (gNodeB, gNB). In addition, in some systems a base station may provide purely edge node signaling functions while in other systems it may provide additional control and/or network management functions.

UEs may be embodied by any of a number of types of devices including but not limited to printed circuit (PC) cards, compact flash devices, external or internal modems, wireless or wireline phones, smartphones, tablets, consumer asset tracking devices, asset tags, and so on. A communication link through which UEs can send signals to a RAN is called an uplink channel (e.g., a reverse traffic channel, a reverse control channel, an access channel, etc.). A communication link through which the RAN can send signals to UEs is called a downlink or forward link channel (e.g., a paging channel, a control channel, a broadcast channel, a forward traffic channel, etc.). As used herein the term traffic channel (TCH) can refer to either an uplink/reverse or downlink/forward traffic channel.

As used herein, the term “cell” or “sector” may correspond to one of a plurality of cells of a base station, or to the base station itself, depending on the context. The term “cell” may refer to a logical communication entity used for communication with a base station (for example, over a carrier), and may be associated with an identifier for distinguishing neighboring cells (for example, a physical cell identifier (PCID), a virtual cell identifier (VCID)) operating via the same or a different carrier. In some examples, a carrier may support multiple cells, and different cells may be configured according to different protocol types (for example, machine-type communication (MTC), narrowband Internet-of-Things (NB-IoT), enhanced mobile broadband (eMBB), or others) that may provide access for different types of devices. In some examples, the term “cell” may refer to a portion of a geographic coverage area (for example, a sector) over which the logical entity operates.

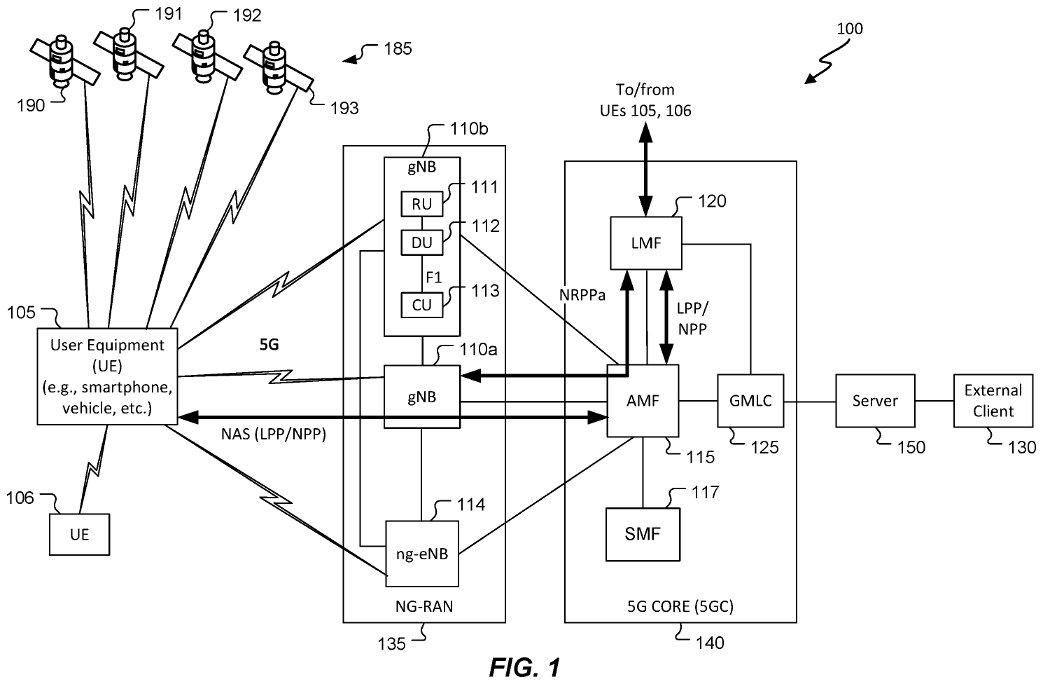

Referring to FIG. 1, an example of a communication system 100 includes a UE 105, a UE 106, a Radio Access Network (RAN), here a Fifth Generation (5G) Next Generation (NG) RAN (NG-RAN) 135, a 5G Core Network (5GC) 140, and a server 150. The UE 105 and/or the UE 106 may be, e.g., an IoT device, a location tracker device, a cellular telephone, a vehicle (e.g., a car, a truck, a bus, a boat, etc.), or other device. A 5G network may also be referred to as a New Radio (NR) network; NG-RAN 135 may be referred to as a 5G RAN or as an NR RAN; and 5GC 140 may be referred to as an NG Core network (NGC). Standardization of an NG-RAN and 5GC is ongoing in the 3rd Generation Partnership Project (3GPP). Accordingly, the NG-RAN 135 and the 5GC 140 may conform to current or future standards for 5G support from 3GPP. The NG-RAN 135 may be another type of RAN, e.g., a 3G RAN, a 4G Long Term Evolution (LTE) RAN, etc. The UE 106 may be configured and coupled similarly to the UE 105 to send and/or receive signals to/from similar other entities in the system 100, but such signaling is not indicated in FIG. 1 for the sake of simplicity of the figure. Similarly, the discussion focuses on the UE 105 for the sake of simplicity. The communication system 100 may utilize information from a constellation 185 of satellite vehicles (SVs) 190, 191, 192, 193 for a Satellite Positioning System (SPS) (e.g., a Global Navigation Satellite System (GNSS)) like the Global Positioning System (GPS), the Global Navigation Satellite System (GLONASS), Galileo, or Beidou or some other local or regional SPS such as the Indian Regional Navigational Satellite System (IRNSS), the European Geostationary Navigation Overlay Service (EGNOS), or the Wide Area Augmentation System (WAAS). Additional components of the communication system 100 are described below. The communication system 100 may include additional or alternative components.

As shown in FIG. 1, the NG-RAN 135 includes NR nodeBs (gNBs) 110a, 110b, and a next generation eNodeB (ng-eNB) 114, and the 5GC 140 includes an Access and Mobility Management Function (AMF) 115, a Session Management Function (SMF) 117, a Location Management Function (LMF) 120, and a Gateway Mobile Location Center (GMLC) 125. The gNBs 110a, 110b and the ng-eNB 114 are communicatively coupled to each other, are each configured to bi-directionally wirelessly communicate with the UE 105, and are each communicatively coupled to, and configured to bi-directionally communicate with, the AMF 115. The gNBs 110a, 110b, and the ng-eNB 114 may be referred to as base stations (BSs). The AMF 115, the SMF 117, the LMF 120, and the GMLC 125 are communicatively coupled to each other, and the GMLC is communicatively coupled to an external client 130. The SMF 117 may serve as an initial contact point of a Service Control Function (SCF) (not shown) to create, control, and delete media sessions. Base stations such as the gNBs 110a, 110b and/or the ng-eNB 114 may be a macro cell (e.g., a high-power cellular base station), or a small cell (e.g., a low-power cellular base station), or an access point (e.g., a short-range base station configured to communicate with short-range technology such as WiFi, WiFi-Direct (WiFi-D), Bluetooth®, Bluetooth®-low energy (BLE), Zigbee, etc. One or more BSs, e.g., one or more of the gNBs 110a, 110b and/or the ng-eNB 114 may be configured to communicate with the UE 105 via multiple carriers. Each of the gNBs 110a, 110b and the ng-eNB 114 may provide communication coverage for a respective geographic region, e.g. a cell. Each cell may be partitioned into multiple sectors as a function of the base station antennas.

FIG. 1 provides a generalized illustration of various components, any or all of which may be utilized as appropriate, and each of which may be duplicated or omitted as necessary. Specifically, although one UE 105 is illustrated, many UEs (e.g., hundreds, thousands, millions, etc.) may be utilized in the communication system 100. Similarly, the communication system 100 may include a larger (or smaller) number of SVs (i.e., more or fewer than the four SVs 190-193 shown), gNBs 110a, 110b, ng-eNBs 114, AMFs 115, external clients 130, and/or other components. The illustrated connections that connect the various components in the communication system 100 include data and signaling connections which may include additional (intermediary) components, direct or indirect physical and/or wireless connections, and/or additional networks. Furthermore, components may be rearranged, combined, separated, substituted, and/or omitted, depending on desired functionality.

While FIG. 1 illustrates a 5G-based network, similar network implementations and configurations may be used for other communication technologies, such as 3G, Long Term Evolution (LTE), etc. Implementations described herein (be they for 5G technology and/or for one or more other communication technologies and/or protocols) may be used to transmit (or broadcast) directional synchronization signals, receive and measure directional signals at UEs (e.g., the UE 105) and/or provide location assistance to the UE 105 (via the GMLC 125 or other location server) and/or compute a location for the UE 105 at a location-capable device such as the UE 105, the gNB 110a, 110b, or the LMF 120 based on measurement quantities received at the UE 105 for such directionally-transmitted signals. The gateway mobile location center (GMLC) 125, the location management function (LMF) 120, the access and mobility management function (AMF) 115, the SMF 117, the ng-eNB (eNodeB) 114 and the gNBs (gNodeBs) 110a, 110b are examples and may, in various embodiments, be replaced by or include various other location server functionality and/or base station functionality respectively.

The system 100 is capable of wireless communication in that components of the system 100 can communicate with one another (at least some times using wireless connections) directly or indirectly, e.g., via the gNBs 110a, 110b, the ng-eNB 114, and/or the 5GC 140 (and/or one or more other devices not shown, such as one or more other base transceiver stations). For indirect communications, the communications may be altered during transmission from one entity to another, e.g., to alter header information of data packets, to change format, etc. The UE 105 may include multiple UEs and may be a mobile wireless communication device, but may communicate wirelessly and via wired connections. The UE 105 may be any of a variety of devices, e.g., a smartphone, a tablet computer, a vehicle-based device, etc., but these are examples as the UE 105 is not required to be any of these configurations, and other configurations of UEs may be used. Other UEs may include wearable devices (e.g., smart watches, smart jewelry, smart glasses or headsets, etc.). Still other UEs may be used, whether currently existing or developed in the future. Further, other wireless devices (whether mobile or not) may be implemented within the system 100 and may communicate with each other and/or with the UE 105, the gNBs 110a, 110b, the ng-eNB 114, the 5GC 140, and/or the external client 130. For example, such other devices may include internet of thing (IoT) devices, medical devices, home entertainment and/or automation devices, etc. The 5GC 140 may communicate with the external client 130 (e.g., a computer system), e.g., to allow the external client 130 to request and/or receive location information regarding the UE 105 (e.g., via the GMLC 125).

The UE 105 or other devices may be configured to communicate in various networks and/or for various purposes and/or using various technologies (e.g., 5G, Wi-Fi communication, multiple frequencies of Wi-Fi communication, satellite positioning, one or more types of communications (e.g., GSM (Global System for Mobiles), CDMA (Code Division Multiple Access), LTE (Long-Term Evolution), V2X (Vehicle-to-Everything, e.g., V2P (Vehicle-to-Pedestrian), V2I (Vehicle-to-Infrastructure), V2V (Vehicle-to-Vehicle), etc.), IEEE 802.11p, etc.). V2X communications may be cellular (Cellular-V2X (C-V2X)) and/or WiFi (e.g., DSRC (Dedicated Short-Range Connection)). The system 100 may support operation on multiple carriers (waveform signals of different frequencies). Multi-carrier transmitters can transmit modulated signals simultaneously on the multiple carriers. Each modulated signal may be a Code Division Multiple Access (CDMA) signal, a Time Division Multiple Access (TDMA) signal, an Orthogonal Frequency Division Multiple Access (OFDMA) signal, a Single-Carrier Frequency Division Multiple Access (SC-FDMA) signal, etc. Each modulated signal may be sent on a different carrier and may carry pilot, overhead information, data, etc. The UEs 105, 106 may communicate with each other through UE-to-UE sidelink (SL) communications by transmitting over one or more sidelink channels such as a physical sidelink synchronization channel (PSSCH), a physical sidelink broadcast channel (PSBCH), or a physical sidelink control channel (PSCCH).

The UE 105 may comprise and/or may be referred to as a device, a mobile device, a wireless device, a mobile terminal, a terminal, a mobile station (MS), a Secure User Plane Location (SUPL) Enabled Terminal (SET), or by some other name. Moreover, the UE 105 may correspond to a cellphone, smartphone, laptop, tablet, PDA, consumer asset tracking device, navigation device, Internet of Things (IoT) device, health monitors, security systems, smart city sensors, smart meters, wearable trackers, or some other portable or moveable device. Typically, though not necessarily, the UE 105 may support wireless communication using one or more Radio Access Technologies (RATs) such as Global System for Mobile communication (GSM), Code Division Multiple Access (CDMA), Wideband CDMA (WCDMA), LTE, High Rate Packet Data (HRPD), IEEE 802.11 WiFi (also referred to as Wi-Fi), Bluetooth® (BT), Worldwide Interoperability for Microwave Access (WiMAX), 5G new radio (NR) (e.g., using the NG-RAN 135 and the 5GC 140), etc. The UE 105 may support wireless communication using a Wireless Local Area Network (WLAN) which may connect to other networks (e.g., the Internet) using a Digital Subscriber Line (DSL) or packet cable, for example. The use of one or more of these RATs may allow the UE 105 to communicate with the external client 130 (e.g., via elements of the 5GC 140 not shown in FIG. 1, or possibly via the GMLC 125) and/or allow the external client 130 to receive location information regarding the UE 105 (e.g., via the GMLC 125).

The UE 105 may include a single entity or may include multiple entities such as in a personal area network where a user may employ audio, video and/or data I/O (input/output) devices and/or body sensors and a separate wireline or wireless modem. An estimate of a location of the UE 105 may be referred to as a location, location estimate, location fix, fix, position, position estimate, or position fix, and may be geographic, thus providing location coordinates for the UE 105 (e.g., latitude and longitude) which may or may not include an altitude component (e.g., height above sea level, height above or depth below ground level, floor level, or basement level). Alternatively, a location of the UE 105 may be expressed as a civic location (e.g., as a postal address or the designation of some point or small area in a building such as a particular room or floor). A location of the UE 105 may be expressed as an area or volume (defined either geographically or in civic form) within which the UE 105 is expected to be located with some probability or confidence level (e.g., 67%, 95%, etc.). A location of the UE 105 may be expressed as a relative location comprising, for example, a distance and direction from a known location. The relative location may be expressed as relative coordinates (e.g., X, Y (and Z) coordinates) defined relative to some origin at a known location which may be defined, e.g., geographically, in civic terms, or by reference to a point, area, or volume, e.g., indicated on a map, floor plan, or building plan. In the description contained herein, the use of the term location may comprise any of these variants unless indicated otherwise. When computing the location of a UE, it is common to solve for local x, y, and possibly z coordinates and then, if desired, convert the local coordinates into absolute coordinates (e.g., for latitude, longitude, and altitude above or below mean sea level).

The UE 105 may be configured to communicate with other entities using one or more of a variety of technologies. The UE 105 may be configured to connect indirectly to one or more communication networks via one or more device-to-device (D2D) peer-to-peer (P2P) links. The D2D P2P links may be supported with any appropriate D2D radio access technology (RAT), such as LTE Direct (LTE-D), WiFi Direct (WiFi-D), Bluetooth®, and so on. One or more of a group of UEs utilizing D2D communications may be within a geographic coverage area of a Transmission/Reception Point (TRP) such as one or more of the gNBs 110a, 110b, and/or the ng-eNB 114. Other UEs in such a group may be outside such geographic coverage areas, or may be otherwise unable to receive transmissions from a base station. Groups of UEs communicating via D2D communications may utilize a one-to-many (1:M) system in which each UE may transmit to other UEs in the group. A TRP may facilitate scheduling of resources for D2D communications. In other cases, D2D communications may be carried out between UEs without the involvement of a TRP. One or more of a group of UEs utilizing D2D communications may be within a geographic coverage area of a TRP. Other UEs in such a group may be outside such geographic coverage areas, or be otherwise unable to receive transmissions from a base station. Groups of UEs communicating via D2D communications may utilize a one-to-many (1:M) system in which each UE may transmit to other UEs in the group. A TRP may facilitate scheduling of resources for D2D communications. In other cases, D2D communications may be carried out between UEs without the involvement of a TRP.

Base stations (BSs) in the NG-RAN 135 shown in FIG. 1 include NR Node Bs, referred to as the gNBs 110a and 110b. Pairs of the gNBs 110a, 110b in the NG-RAN 135 may be connected to one another via one or more other gNBs. Access to the 5G network is provided to the UE 105 via wireless communication between the UE 105 and one or more of the gNBs 110a, 110b, which may provide wireless communications access to the 5GC 140 on behalf of the UE 105 using 5G. In FIG. 1, the serving gNB for the UE 105 is assumed to be the gNB 110a, although another gNB (e.g. the gNB 110b) may act as a serving gNB if the UE 105 moves to another location or may act as a secondary gNB to provide additional throughput and bandwidth to the UE 105.

Base stations (BSs) in the NG-RAN 135 shown in FIG. 1 may include the ng-eNB 114, also referred to as a next generation evolved Node B. The ng-eNB 114 may be connected to one or more of the gNBs 110a, 110b in the NG-RAN 135, possibly via one or more other gNBs and/or one or more other ng-eNBs. The ng-eNB 114 may provide LTE wireless access and/or evolved LTE (eLTE) wireless access to the UE 105. One or more of the gNBs 110a, 110b and/or the ng-eNB 114 may be configured to function as positioning-only beacons which may transmit signals to assist with determining the position of the UE 105 but may not receive signals from the UE 105 or from other UEs.

The gNBs 110a, 110b and/or the ng-eNB 114 may each comprise one or more TRPs. For example, each sector within a cell of a BS may comprise a TRP, although multiple TRPs may share one or more components (e.g., share a processor but have separate antennas). The system 100 may include macro TRPs exclusively or the system 100 may have TRPs of different types, e.g., macro, pico, and/or femto TRPs, etc. A macro TRP may cover a relatively large geographic area (e.g., several kilometers in radius) and may allow unrestricted access by terminals with service subscription. A pico TRP may cover a relatively small geographic area (e.g., a pico cell) and may allow unrestricted access by terminals with service subscription. A femto or home TRP may cover a relatively small geographic area (e.g., a femto cell) and may allow restricted access by terminals having association with the femto cell (e.g., terminals for users in a home).

Each of the gNBs 110a, 110b and/or the ng-eNB 114 may include a radio unit (RU), a distributed unit (DU), and a central unit (CU). For example, the gNB 110a includes an RU 111, a DU 112, and a CU 113. The RU 111, DU 112, and CU 113 divide functionality of the gNB 110a. While the gNB 110a is shown with a single RU, a single DU, and a single CU, a gNB may include one or more RUs, one or more DUs, and/or one or more CUs. An interface between the CU 113 and the DU 112 is referred to as an F1 interface. The RU 111 is configured to perform digital front end (DFE) functions (e.g., analog-to-digital conversion, filtering, power amplification, transmission/reception) and digital beamforming, and includes a portion of the physical (PHY) layer. The RU 111 may perform the DFE using massive multiple input/multiple output (MIMO) and may be integrated with one or more antennas of the gNB 110a. The DU 112 hosts the Radio Link Control (RLC), Medium Access Control (MAC), and physical layers of the gNB 110a. One DU can support one or more cells, and each cell is supported by a single DU. The operation of the DU 112 is controlled by the CU 113. The CU 113 is configured to perform functions for transferring user data, mobility control, radio access network sharing, positioning, session management, etc. although some functions are allocated exclusively to the DU 112. The CU 113 hosts the Radio Resource Control (RRC), Service Data Adaptation Protocol (SDAP), and Packet Data Convergence Protocol (PDCP) protocols of the gNB 110a. The UE 105 may communicate with the CU 113 via RRC, SDAP, and PDCP layers, with the DU 112 via the RLC, MAC, and PHY layers, and with the RU 111 via the PHY layer.

As noted, while FIG. 1 depicts nodes configured to communicate according to 5G communication protocols, nodes configured to communicate according to other communication protocols, such as, for example, an LTE protocol or IEEE 802.11x protocol, may be used. For example, in an Evolved Packet System (EPS) providing LTE wireless access to the UE 105, a RAN may comprise an Evolved Universal Mobile Telecommunications System (UMTS) Terrestrial Radio Access Network (E-UTRAN) which may comprise base stations comprising evolved Node Bs (eNBs). A core network for EPS may comprise an Evolved Packet Core (EPC). An EPS may comprise an E-UTRAN plus EPC, where the E-UTRAN corresponds to the NG-RAN 135 and the EPC corresponds to the 5GC 140 in FIG. 1.

The gNBs 110a, 110b and the ng-eNB 114 may communicate with the AMF 115, which, for positioning functionality, communicates with the LMF 120. The AMF 115 may support mobility of the UE 105, including cell change and handover and may participate in supporting a signaling connection to the UE 105 and possibly data and voice bearers for the UE 105. The LMF 120 may communicate directly with the UE 105, e.g., through wireless communications, or directly with the gNBs 110a, 110b and/or the ng-eNB 114. The LMF 120 may support positioning of the UE 105 when the UE 105 accesses the NG-RAN 135 and may support position procedures/methods such as Assisted GNSS (A-GNSS), Observed Time Difference of Arrival (OTDOA) (e.g., Downlink (DL) OTDOA or Uplink (UL) OTDOA), Round Trip Time (RTT), Multi-Cell RTT, Real Time Kinematic (RTK), Precise Point Positioning (PPP), Differential GNSS (DGNSS), Enhanced Cell ID (E-CID), angle of arrival (AoA), angle of departure (AoD), and/or other position methods. The LMF 120 may process location services requests for the UE 105, e.g., received from the AMF 115 or from the GMLC 125. The LMF 120 may be connected to the AMF 115 and/or to the GMLC 125. The LMF 120 may be referred to by other names such as a Location Manager (LM), Location Function (LF), commercial LMF (CLMF), or value added LMF (VLMF). A node/system that implements the LMF 120 may additionally or alternatively implement other types of location-support modules, such as an Enhanced Serving Mobile Location Center (E-SMLC) or a Secure User Plane Location (SUPL) Location Platform (SLP). At least part of the positioning functionality (including derivation of the location of the UE 105) may be performed at the UE 105 (e.g., using signal measurements obtained by the UE 105 for signals transmitted by wireless nodes such as the gNBs 110a, 110b and/or the ng-eNB 114, and/or assistance data provided to the UE 105, e.g. by the LMF 120). The AMF 115 may serve as a control node that processes signaling between the UE 105 and the 5GC 140, and may provide QoS (Quality of Service) flow and session management. The AMF 115 may support mobility of the UE 105 including cell change and handover and may participate in supporting signaling connection to the UE 105.

The server 150, e.g., a cloud server, is configured to obtain and provide location estimates of the UE 105 to the external client 130. The server 150 may, for example, be configured to run a microservice/service that obtains the location estimate of the UE 105. The server 150 may, for example, pull the location estimate from (e.g., by sending a location request to) the UE 105, one or more of the gNBs 110a, 110b (e.g., via the RU 111, the DU 112, and the CU 113) and/or the ng-eNB 114, and/or the LMF 120. As another example, the UE 105, one or more of the gNBs 110a, 110b (e.g., via the RU 111, the DU 112, and the CU 113), and/or the LMF 120 may push the location estimate of the UE 105 to the server 150.

The GMLC 125 may support a location request for the UE 105 received from the external client 130 via the server 150 and may forward such a location request to the AMF 115 for forwarding by the AMF 115 to the LMF 120 or may forward the location request directly to the LMF 120. A location response from the LMF 120 (e.g., containing a location estimate for the UE 105) may be returned to the GMLC 125 either directly or via the AMF 115 and the GMLC 125 may then return the location response (e.g., containing the location estimate) to the external client 130 via the server 150. The GMLC 125 is shown connected to both the AMF 115 and LMF 120, though may not be connected to the AMF 115 or the LMF 120 in some implementations.

As further illustrated in FIG. 1, the LMF 120 may communicate with the gNBs 110a, 110b and/or the ng-eNB 114 using a New Radio Position Protocol A (which may be referred to as NPPa or NRPPa), which may be defined in 3GPP Technical Specification (TS) 38.455. NRPPa may be the same as, similar to, or an extension of the LTE Positioning Protocol A (LPPa) defined in 3GPP TS 36.455, with NRPPa messages being transferred between the gNB 110a (or the gNB 110b) and the LMF 120, and/or between the ng-eNB 114 and the LMF 120, via the AMF 115. As further illustrated in FIG. 1, the LMF 120 and the UE 105 may communicate using an LTE Positioning Protocol (LPP), which may be defined in 3GPP TS 36.355. The LMF 120 and the UE 105 may also or instead communicate using a New Radio Positioning Protocol (which may be referred to as NPP or NRPP), which may be the same as, similar to, or an extension of LPP. Here, LPP and/or NPP messages may be transferred between the UE 105 and the LMF 120 via the AMF 115 and the serving gNB 110a, 110b or the serving ng-eNB 114 for the UE 105. For example, LPP and/or NPP messages may be transferred between the LMF 120 and the AMF 115 using a 5G Location Services Application Protocol (LCS AP) and may be transferred between the AMF 115 and the UE 105 using a 5G Non-Access Stratum (NAS) protocol. The LPP and/or NPP protocol may be used to support positioning of the UE 105 using UE-assisted and/or UE-based position methods such as A-GNSS, RTK, OTDOA and/or E-CID. The NRPPa protocol may be used to support positioning of the UE 105 using network-based position methods such as E-CID (e.g., when used with measurements obtained by the gNB 110a, 110b or the ng-eNB 114) and/or may be used by the LMF 120 to obtain location related information from the gNBs 110a, 110b and/or the ng-eNB 114, such as parameters defining directional SS transmissions from the gNBs 110a, 110b, and/or the ng-eNB 114. The LMF 120 may be co-located or integrated with a gNB or a TRP, or may be disposed remote from the gNB and/or the TRP and configured to communicate directly or indirectly with the gNB and/or the TRP.

With a UE-assisted position method, the UE 105 may obtain location measurements and send the measurements to a location server (e.g., the LMF 120) for computation of a location estimate for the UE 105. For example, the location measurements may include one or more of a Received Signal Strength Indication (RSSI), Round Trip signal propagation Time (RTT), Reference Signal Time Difference (RSTD), Reference Signal Received Power (RSRP) and/or Reference Signal Received Quality (RSRQ) for the gNBs 110a, 110b, the ng-eNB 114, and/or a WLAN AP. The location measurements may also or instead include measurements of GNSS pseudorange, code phase, and/or carrier phase for the SVs 190-193.

With a UE-based position method, the UE 105 may obtain location measurements (e.g., which may be the same as or similar to location measurements for a UE-assisted position method) and may compute a location of the UE 105 (e.g., with the help of assistance data received from a location server such as the LMF 120 or broadcast by the gNBs 110a, 110b, the ng-eNB 114, or other base stations or APs).

With a network-based position method, one or more base stations (e.g., the gNBs 110a, 110b, and/or the ng-eNB 114) or APs may obtain location measurements (e.g., measurements of RSSI, RTT, RSRP, RSRQ or Time of Arrival (ToA) for signals transmitted by the UE 105) and/or may receive measurements obtained by the UE 105. The one or more base stations or APs may send the measurements to a location server (e.g., the LMF 120) for computation of a location estimate for the UE 105.

Information provided by the gNBs 110a, 110b, and/or the ng-eNB 114 to the LMF 120 using NRPPa may include timing and configuration information for directional SS transmissions and location coordinates. The LMF 120 may provide some or all of this information to the UE 105 as assistance data in an LPP and/or NPP message via the NG-RAN 135 and the 5GC 140.

An LPP or NPP message sent from the LMF 120 to the UE 105 may instruct the UE 105 to do any of a variety of things depending on desired functionality. For example, the LPP or NPP message could contain an instruction for the UE 105 to obtain measurements for GNSS (or A-GNSS), WLAN, E-CID, and/or OTDOA (or some other position method). In the case of E-CID, the LPP or NPP message may instruct the UE 105 to obtain one or more measurement quantities (e.g., beam ID, beam width, mean angle, RSRP, RSRQ measurements) of directional signals transmitted within particular cells supported by one or more of the gNBs 110a, 110b, and/or the ng-eNB 114 (or supported by some other type of base station such as an eNB or WiFi AP). The UE 105 may send the measurement quantities back to the LMF 120 in an LPP or NPP message (e.g., inside a 5G NAS message) via the serving gNB 110a (or the serving ng-eNB 114) and the AMF 115.

As noted, while the communication system 100 is described in relation to 5G technology, the communication system 100 may be implemented to support other communication technologies, such as GSM, WCDMA, LTE, etc., that are used for supporting and interacting with mobile devices such as the UE 105 (e.g., to implement voice, data, positioning, and other functionalities). In some such embodiments, the 5GC 140 may be configured to control different air interfaces. For example, the 5GC 140 may be connected to a WLAN using a Non-3GPP InterWorking Function (N3IWF, not shown FIG. 1) in the 5GC 140. For example, the WLAN may support IEEE 802.11 WiFi access for the UE 105 and may comprise one or more WiFi APs. Here, the N3IWF may connect to the WLAN and to other elements in the 5GC 140 such as the AMF 115. In some embodiments, both the NG-RAN 135 and the 5GC 140 may be replaced by one or more other RANs and one or more other core networks. For example, in an EPS, the NG-RAN 135 may be replaced by an E-UTRAN containing eNBs and the 5GC 140 may be replaced by an EPC containing a Mobility Management Entity (MME) in place of the AMF 115, an E-SMLC in place of the LMF 120, and a GMLC that may be similar to the GMLC 125. In such an EPS, the E-SMLC may use LPPa in place of NRPPa to send and receive location information to and from the eNBs in the E-UTRAN and may use LPP to support positioning of the UE 105. In these other embodiments, positioning of the UE 105 using directional PRSs may be supported in an analogous manner to that described herein for a 5G network with the difference that functions and procedures described herein for the gNBs 110a, 110b, the ng-eNB 114, the AMF 115, and the LMF 120 may, in some cases, apply instead to other network elements such eNBs, WiFi APs, an MME, and an E-SMLC.

As noted, in some embodiments, positioning functionality may be implemented, at least in part, using the directional SS beams, sent by base stations (such as the gNBs 110a, 110b, and/or the ng-eNB 114) that are within range of the UE whose position is to be determined (e.g., the UE 105 of FIG. 1). The UE may, in some instances, use the directional SS beams from a plurality of base stations (such as the gNBs 110a. 110b, the ng-eNB 114, etc.) to compute the UE's position.

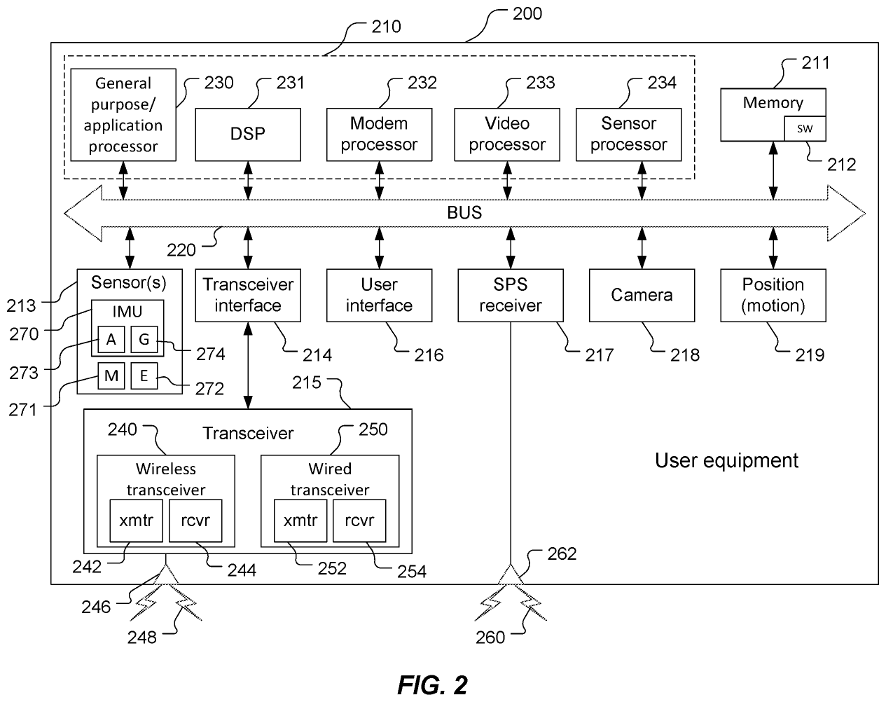

Referring also to FIG. 2, a UE 200 is an example of the UE 105 and comprises a computing platform including a processor 210, memory 211 including software (SW) 212, one or more sensors 213, a transceiver interface 214 for a transceiver 215 (that includes one or more wireless transceivers 240, and a wired transceiver 250), a user interface 216, a Satellite Positioning System (SPS) receiver 217, a camera 218, and a position (motion) device 219. The processor 210, the memory 211, the sensor(s) 213, the transceiver interface 214, the user interface 216, the SPS receiver 217, the camera 218, and the position (motion) device 219 may be communicatively coupled to each other by a bus 220 (which may be configured, e.g., for optical and/or electrical communication). One or more of the shown apparatus (e.g., the camera 218, the position (motion) device 219, and/or one or more of the sensor(s) 213, etc.) may be omitted from the UE 200. The processor 210 may include one or more intelligent hardware devices, e.g., a central processing unit (CPU), a microcontroller, an application specific integrated circuit (ASIC), etc. The processor 210 may comprise multiple processors including a general-purpose/application processor 230, a Digital Signal Processor (DSP) 231, a modem processor 232, a video processor 233, and/or a sensor processor 234. One or more of the processors 230-234 may comprise multiple devices (e.g., multiple processors). For example, the sensor processor 234 may comprise, e.g., processors for radio frequency (RF) sensing (with one or more wireless signals transmitted and reflection(s) used to identify, map, and/or track an object), and/or ultrasound, etc. The modem processor 232 may support dual SIM/dual connectivity (or even more SIMs). For example, a SIM (Subscriber Identity Module or Subscriber Identification Module) may be used by an Original Equipment Manufacturer (OEM), and another SIM may be used by an end user of the UE 200 for connectivity. The memory 211 is a non-transitory storage medium that may include random access memory (RAM), flash memory, disc memory, and/or read-only memory (ROM), etc. The memory 211 stores the software 212 which may be processor-readable, processor-executable software code containing instructions that are configured to, when executed, cause the processor 210 to perform various functions described herein. Alternatively, the software 212 may not be directly executable by the processor 210 but may be configured to cause the processor 210, e.g., when compiled and executed, to perform the functions. The description may refer to the processor 210 performing a function, but this includes other implementations such as where the processor 210 executes software and/or firmware. The description may refer to the processor 210 performing a function as shorthand for one or more of the processors 230-234 performing the function. The description may refer to the UE 200 performing a function as shorthand for one or more appropriate components of the UE 200 performing the function. The processor 210 may include a memory with stored instructions in addition to and/or instead of the memory 211. Functionality of the processor 210 is discussed more fully below.

The configuration of the UE 200 shown in FIG. 2 is an example and not limiting of the disclosure, including the claims, and other configurations may be used. For example, an example configuration of the UE includes one or more of the processors 230-234 of the processor 210, the memory 211, and the wireless transceiver 240. Other example configurations include one or more of the processors 230-234 of the processor 210, the memory 211, the wireless transceiver 240, and one or more of the sensor(s) 213, the user interface 216, the SPS receiver 217, the camera 218, the PMD 219, and/or the wired transceiver 250.

The UE 200 may comprise the modem processor 232 that may be capable of performing baseband processing of signals received and down-converted by the transceiver 215 and/or the SPS receiver 217. The modem processor 232 may perform baseband processing of signals to be upconverted for transmission by the transceiver 215. Also or alternatively, baseband processing may be performed by the general-purpose processor 230 and/or the DSP 231. Other configurations, however, may be used to perform baseband processing.

The UE 200 may include the sensor(s) 213 that may include, for example, an Inertial Measurement Unit (IMU) 270, one or more magnetometers 271, and/or one or more environment sensors 272. The IMU 270 may comprise one or more inertial sensors, for example, one or more accelerometers 273 (e.g., collectively responding to acceleration of the UE 200 in three dimensions) and/or one or more gyroscopes 274. The magnetometer(s) may provide measurements to determine orientation (e.g., relative to magnetic north and/or true north) that may be used for any of a variety of purposes, e.g., to support one or more compass applications. The environment sensor(s) 272 may comprise, for example, one or more temperature sensors, one or more barometric pressure sensors, one or more ambient light sensors, one or more camera imagers, and/or one or more microphones, etc. The sensor(s) 213 may generate analog and/or digital signals indications of which may be stored in the memory 211 and processed by the DSP 231 and/or the general-purpose processor 230 in support of one or more applications such as, for example, applications directed to positioning and/or navigation operations.

The sensor(s) 213 may be used in relative location measurements, relative location determination, motion determination, etc. Information detected by the sensor(s) 213 may be used for motion detection, relative displacement, dead reckoning, sensor-based location determination, and/or sensor-assisted location determination. The sensor(s) 213 may be useful to determine whether the UE 200 is fixed (stationary) or mobile and/or whether to report certain useful information to the LMF 120 regarding the mobility of the UE 200. For example, based on the information obtained/measured by the sensor(s) 213, the UE 200 may notify/report to the LMF 120 that the UE 200 has detected movements or that the UE 200 has moved, and report the relative displacement/distance (e.g., via dead reckoning, or sensor-based location determination, or sensor-assisted location determination enabled by the sensor(s) 213). In another example, for relative positioning information, the sensors/IMU can be used to determine the angle and/or orientation of the other device with respect to the UE 200, etc.

The IMU 270 may be configured to provide measurements about a direction of motion and/or a speed of motion of the UE 200, which may be used in relative location determination. For example, the one or more accelerometers 273 and/or the one or more gyroscopes 274 of the IMU 270 may detect, respectively, a linear acceleration and a speed of rotation of the UE 200. The linear acceleration and speed of rotation measurements of the UE 200 may be integrated over time to determine an instantaneous direction of motion as well as a displacement of the UE 200. The instantaneous direction of motion and the displacement may be integrated to track a location of the UE 200. For example, a reference location of the UE 200 may be determined, e.g., using the SPS receiver 217 (and/or by some other means) for a moment in time and measurements from the accelerometer(s) 273 and gyroscope(s) 274 taken after this moment in time may be used in dead reckoning to determine present location of the UE 200 based on movement (direction and distance) of the UE 200 relative to the reference location.

The magnetometer(s) 271 may determine magnetic field strengths in different directions which may be used to determine orientation of the UE 200. For example, the orientation may be used to provide a digital compass for the UE 200. The magnetometer(s) 271 may include a two-dimensional magnetometer configured to detect and provide indications of magnetic field strength in two orthogonal dimensions. Also or alternatively, the magnetometer(s) 271 may include a three-dimensional magnetometer configured to detect and provide indications of magnetic field strength in three orthogonal dimensions. The magnetometer(s) 271 may provide means for sensing a magnetic field and providing indications of the magnetic field, e.g., to the processor 210.

The transceiver 215 may include a wireless transceiver 240 and a wired transceiver 250 configured to communicate with other devices through wireless connections and wired connections, respectively. For example, the wireless transceiver 240 may include a transmitter 242 and receiver 244 coupled to one or more antennas 246 for transmitting (e.g., on one or more uplink channels and/or one or more sidelink channels) and/or receiving (e.g., on one or more downlink channels and/or one or more sidelink channels) wireless signals 248 and transducing signals from the wireless signals 248 to wired (e.g., electrical and/or optical) signals and from wired (e.g., electrical and/or optical) signals to the wireless signals 248. Thus, the transmitter 242 may include multiple transmitters that may be discrete components or combined/integrated components, and/or the receiver 244 may include multiple receivers that may be discrete components or combined/integrated components. The wireless transceiver 240 may be configured to communicate signals (e.g., with TRPs and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long-Term Evolution), LTE Direct (LTE-D), 3GPP LTE-Vehicle-to-Everything (V2X), PC5, IEEE 802.11 (including IEEE 802.11p), WiFi, WiFi Direct (WiFi-D), Bluetooth®, Zigbee etc. New Radio may use mm-wave frequencies and/or sub-6 GHz frequencies. The wired transceiver 250 may include a transmitter 252 and a receiver 254 configured for wired communication, e.g., with the NG-RAN 135 to send communications to, and receive communications from, the gNB 110a, for example. The transmitter 252 may include multiple transmitters that may be discrete components or combined/integrated components, and/or the receiver 254 may include multiple receivers that may be discrete components or combined/integrated components. The wired transceiver 250 may be configured, e.g., for optical communication and/or electrical communication. The transceiver 215 may be communicatively coupled to the transceiver interface 214, e.g., by optical and/or electrical connection. The transceiver interface 214 may be at least partially integrated with the transceiver 215.

The user interface 216 may comprise one or more of several devices such as, for example, a speaker, microphone, display device, vibration device, keyboard, touch screen, etc. The user interface 216 may include more than one of any of these devices. The user interface 216 may be configured to enable a user to interact with one or more applications hosted by the UE 200. For example, the user interface 216 may store indications of analog and/or digital signals in the memory 211 to be processed by DSP 231 and/or the general-purpose processor 230 in response to action from a user. Similarly, applications hosted on the UE 200 may store indications of analog and/or digital signals in the memory 211 to present an output signal to a user. The user interface 216 may include an audio input/output (I/O) device comprising, for example, a speaker, a microphone, digital-to-analog circuitry, analog-to-digital circuitry, an amplifier and/or gain control circuitry (including more than one of any of these devices). Other configurations of an audio I/O device may be used. Also or alternatively, the user interface 216 may comprise one or more touch sensors responsive to touching and/or pressure, e.g., on a keyboard and/or touch screen of the user interface 216.

The SPS receiver 217 (e.g., a Global Positioning System (GPS) receiver) may be capable of receiving and acquiring SPS signals 260 via an SPS antenna 262. The antenna 262 is configured to transduce the wireless SPS signals 260 to wired signals, e.g., electrical or optical signals, and may be integrated with the antenna 246. The SPS receiver 217 may be configured to process, in whole or in part, the acquired SPS signals 260 for estimating a location of the UE 200. For example, the SPS receiver 217 may be configured to determine location of the UE 200 by trilateration using the SPS signals 260. The general-purpose processor 230, the memory 211, the DSP 231 and/or one or more specialized processors (not shown) may be utilized to process acquired SPS signals, in whole or in part, and/or to calculate an estimated location of the UE 200, in conjunction with the SPS receiver 217. The memory 211 may store indications (e.g., measurements) of the SPS signals 260 and/or other signals (e.g., signals acquired from the wireless transceiver 240) for use in performing positioning operations. The general-purpose processor 230, the DSP 231, and/or one or more specialized processors, and/or the memory 211 may provide or support a location engine for use in processing measurements to estimate a location of the UE 200.

The UE 200 may include the camera 218 for capturing still or moving imagery. The camera 218 may comprise, for example, an imaging sensor (e.g., a charge coupled device or a CMOS imager), a lens, analog-to-digital circuitry, frame buffers, etc. Additional processing, conditioning, encoding, and/or compression of signals representing captured images may be performed by the general-purpose processor 230 and/or the DSP 231. Also or alternatively, the video processor 233 may perform conditioning, encoding, compression, and/or manipulation of signals representing captured images. The video processor 233 may decode/decompress stored image data for presentation on a display device (not shown), e.g., of the user interface 216.

The position (motion) device (PMD) 219 may be configured to determine a position and possibly motion of the UE 200. For example, the PMD 219 may communicate with, and/or include some or all of, the SPS receiver 217. The PMD 219 may also or alternatively be configured to determine location of the UE 200 using terrestrial-based signals (e.g., at least some of the wireless signals 248) for trilateration, for assistance with obtaining and using the SPS signals 260, or both. The PMD 219 may be configured to use one or more other techniques (e.g., relying on the UE's self-reported location (e.g., part of the UE's position beacon)) for determining the location of the UE 200, and may use a combination of techniques (e.g., SPS and terrestrial positioning signals) to determine the location of the UE 200. The PMD 219 may include one or more of the sensors 213 (e.g., gyroscope(s), accelerometer(s), magnetometer(s), etc.) that may sense orientation and/or motion of the UE 200 and provide indications thereof that the processor 210 (e.g., the general-purpose processor 230 and/or the DSP 231) may be configured to use to determine motion (e.g., a velocity vector and/or an acceleration vector) of the UE 200. The PMD 219 may be configured to provide indications of uncertainty and/or error in the determined position and/or motion.

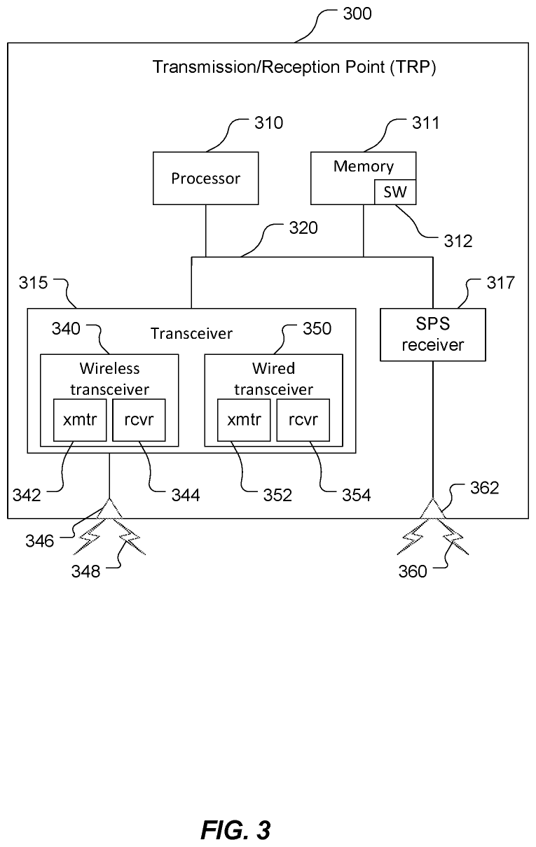

Referring also to FIG. 3, an example of a TRP 300 of the BSs (e.g., gNB 110a, gNB 110b, ng-eNB 114) comprises a computing platform including a processor 310, memory 311 including software (SW) 312, a transceiver 315, and (optionally) an SPS receiver 317. The processor 310, the memory 311, the transceiver 315, and the SPS receiver 317 may be communicatively coupled to each other by a bus 320 (which may be configured, e.g., for optical and/or electrical communication). One or more of the shown apparatus (e.g., a wireless interface and/or the SPS receiver 317) may be omitted from the TRP 300. The SPS receiver 317 may be configured similarly to the SPS receiver 217 to be capable of receiving and acquiring SPS signals 360 via an SPS antenna 362. The processor 310 may include one or more intelligent hardware devices, e.g., a central processing unit (CPU), a microcontroller, an application specific integrated circuit (ASIC), etc. The processor 310 may comprise multiple processors (e.g., including a general-purpose/application processor, a DSP, a modem processor, a video processor, and/or a sensor processor as shown in FIG. 2). The memory 311 is a non-transitory storage medium that may include random access memory (RAM)), flash memory, disc memory, and/or read-only memory (ROM), etc. The memory 311 stores the software 312 which may be processor-readable, processor-executable software code containing instructions that are configured to, when executed, cause the processor 310 to perform various functions described herein. Alternatively, the software 312 may not be directly executable by the processor 310 but may be configured to cause the processor 310, e.g., when compiled and executed, to perform the functions. The description may refer to the processor 310 performing a function, but this includes other implementations such as where the processor 310 executes software and/or firmware. The description may refer to the processor 310 performing a function as shorthand for one or more of the processors contained in the processor 310 performing the function. The description may refer to the TRP 300 performing a function as shorthand for one or more appropriate components of the TRP 300 (and thus of one of the gNB 110a, gNB 110b, ng-eNB 114) performing the function. The processor 310 may include a memory with stored instructions in addition to and/or instead of the memory 311. Functionality of the processor 310 is discussed more fully below.

The transceiver 315 may include a wireless transceiver 340 and a wired transceiver 350 configured to communicate with other devices through wireless connections and wired connections, respectively. For example, the wireless transceiver 340 may include a transmitter 342 and receiver 344 coupled to one or more antennas 346 for transmitting (e.g., on one or more uplink or downlink channels, and/or one or more sidelink channels) and/or receiving (e.g., on one or more downlink or uplink channels, and/or one or more sidelink channels) wireless signals 348 and transducing signals from the wireless signals 348 to wired (e.g., electrical and/or optical) signals and from wired (e.g., electrical and/or optical) signals to the wireless signals 348. Thus, the transmitter 342 may include multiple transmitters that may be discrete components or combined/integrated components, and/or the receiver 344 may include multiple receivers that may be discrete components or combined/integrated components. The wireless transceiver 340 may be configured to communicate signals (e.g., with the UE 200, one or more other UEs, and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long-Term Evolution), LTE Direct (LTE-D), 3GPP LTE-V2X (PC5), IEEE 802.11 (including IEEE 802.11p), WiFi, WiFi Direct (WiFi-D), Bluetooth®, Zigbee etc. The wired transceiver 350 may include a transmitter 352 and a receiver 354 configured for wired communication, e.g., with the network 140 to send communications to, and receive communications from, the LMF 120, for example. The transmitter 352 may include multiple transmitters that may be discrete components or combined/integrated components, and/or the receiver 354 may include multiple receivers that may be discrete components or combined/integrated components. The wired transceiver 350 may be configured, e.g., for optical communication and/or electrical communication.

The configuration of the TRP 300 shown in FIG. 3 is an example and not limiting of the disclosure, including the claims, and other configurations may be used. For example, the description herein discusses that the TRP 300 is configured to perform or performs several functions, but one or more of these functions may be performed by the LMF 120 and/or the UE 200 (i.e., the LMF 120 and/or the UE 200 may be configured to perform one or more of these functions).

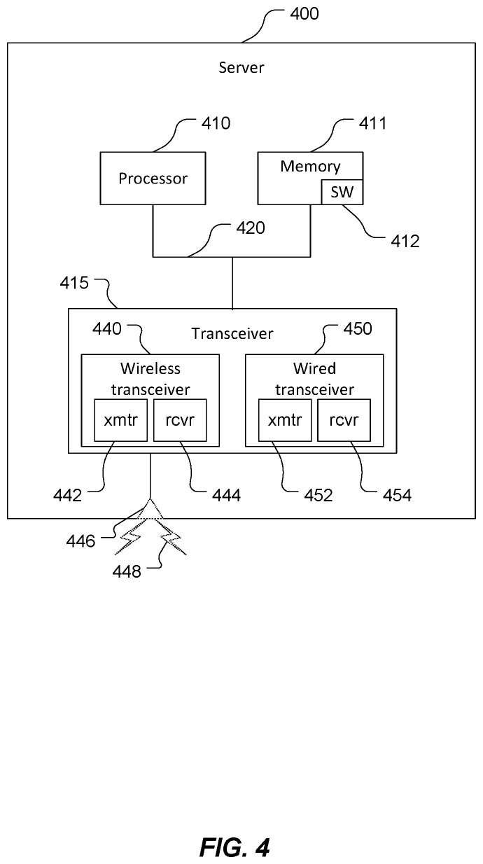

Referring also to FIG. 4, an example of the LMF 120 comprises a computing platform including a processor 410, memory 411 including software (SW) 412, and a transceiver 415. The processor 410, the memory 411, and the transceiver 415 may be communicatively coupled to each other by a bus 420 (which may be configured, e.g., for optical and/or electrical communication). One or more of the shown apparatus (e.g., a wireless interface) may be omitted from the server 400. The processor 410 may include one or more intelligent hardware devices, e.g., a central processing unit (CPU), a microcontroller, an application specific integrated circuit (ASIC), etc. The processor 410 may comprise multiple processors (e.g., including a general-purpose/application processor, a DSP, a modem processor, a video processor, and/or a sensor processor as shown in FIG. 2). The memory 411 is a non-transitory storage medium that may include random access memory (RAM)), flash memory, disc memory, and/or read-only memory (ROM), etc. The memory 411 stores the software 412 which may be processor-readable, processor-executable software code containing instructions that are configured to, when executed, cause the processor 410 to perform various functions described herein. Alternatively, the software 412 may not be directly executable by the processor 410 but may be configured to cause the processor 410, e.g., when compiled and executed, to perform the functions. The description may refer to the processor 410 performing a function, but this includes other implementations such as where the processor 410 executes software and/or firmware. The description may refer to the processor 410 performing a function as shorthand for one or more of the processors contained in the processor 410 performing the function. The description may refer to the server 400 (or the LMF 120) performing a function as shorthand for one or more appropriate components of the server 400 (e.g., the LMF 120) performing the function. The processor 410 may include a memory with stored instructions in addition to and/or instead of the memory 411. Functionality of the processor 410 is discussed more fully below.

The transceiver 415 may include a wireless transceiver 440 and a wired transceiver 450 configured to communicate with other devices through wireless connections and wired connections, respectively. For example, the wireless transceiver 440 may include a transmitter 442 and receiver 444 coupled to one or more antennas 446 for transmitting (e.g., on one or more uplink channels) and/or receiving (e.g., on one or more downlink channels) wireless signals 448 and transducing signals from the wireless signals 448 to wired (e.g., electrical and/or optical) signals and from wired (e.g., electrical and/or optical) signals to the wireless signals 448. Thus, the transmitter 442 may include multiple transmitters that may be discrete components or combined/integrated components, and/or the receiver 444 may include multiple receivers that may be discrete components or combined/integrated components. The wireless transceiver 440 may be configured to communicate signals (e.g., with the UE 200, one or more other UEs, and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long-Term Evolution), LTE Direct (LTE-D), 3GPP LTE-V2X (PC5), IEEE 802.11 (including IEEE 802.11p), WiFi, WiFi Direct (WiFi-D), Bluetooth®, Zigbee etc. The wired transceiver 450 may include a transmitter 452 and a receiver 454 configured for wired communication, e.g., with the NG-RAN 135 to send communications to, and receive communications from, the TRP 300, for example. The transmitter 452 may include multiple transmitters that may be discrete components or combined/integrated components, and/or the receiver 454 may include multiple receivers that may be discrete components or combined/integrated components. The wired transceiver 450 may be configured, e.g., for optical communication and/or electrical communication.

The configuration of the server 400 shown in FIG. 4 is an example and not limiting of the disclosure, including the claims, and other configurations may be used. For example, the wireless transceiver 440 may be omitted. Also or alternatively, the description herein discusses that the server 400 is configured to perform or performs several functions, but one or more of these functions may be performed by the TRP 300 and/or the UE 200 (i.e., the TRP 300 and/or the UE 200 may be configured to perform one or more of these functions).

One or more of many different techniques may be used to determine position of an entity such as the UE 105. For example, known position-determination techniques include RTT, multi-RTT. RSTD (e.g., OTDOA, also called TDOA and including UL-TDOA and DL-TDOA), Enhanced Cell Identification (E-CID). DL-AoD, UL-AoA, etc. RTT uses a time for a signal to travel from one entity to another and back to determine a range between the two entities. The range, plus a known location of a first one of the entities and an angle between the two entities (e.g., an azimuth angle) can be used to determine a location of the second of the entities. In multi-RTT (also called multi-cell RTT), multiple ranges from one entity (e.g., a UE) to other entities (e.g., TRPs) and known locations of the other entities may be used to determine the location of the one entity. In RSTD techniques, the difference in travel times between one entity and other entities may be used to determine relative ranges from the other entities and those, combined with known locations of the other entities may be used to determine the location of the one entity. Angles of arrival and/or departure may be used to help determine location of an entity. For example, an angle of arrival or an angle of departure of a signal combined with a range between devices (determined using signal, e.g., a travel time of the signal, a received power of the signal, etc.) and a known location of one of the devices may be used to determine a location of the other device. The angle of arrival or departure may be an azimuth angle relative to a reference direction such as true north. The angle of arrival or departure may be a zenith angle relative to directly upward from an entity (i.e., relative to radially outward from a center of Earth). E-CID uses the identity of a serving cell, the timing advance (i.e., the difference between receive and transmit times at the UE), estimated timing and power of detected neighbor cell signals, and possibly angle of arrival (e.g., of a signal at the UE from the base station or vice versa) to determine location of the UE. In RSTD, the difference in arrival times at a receiving device of signals from different sources along with known locations of the sources and known offset of transmission times from the sources are used to determine the location of the receiving device.

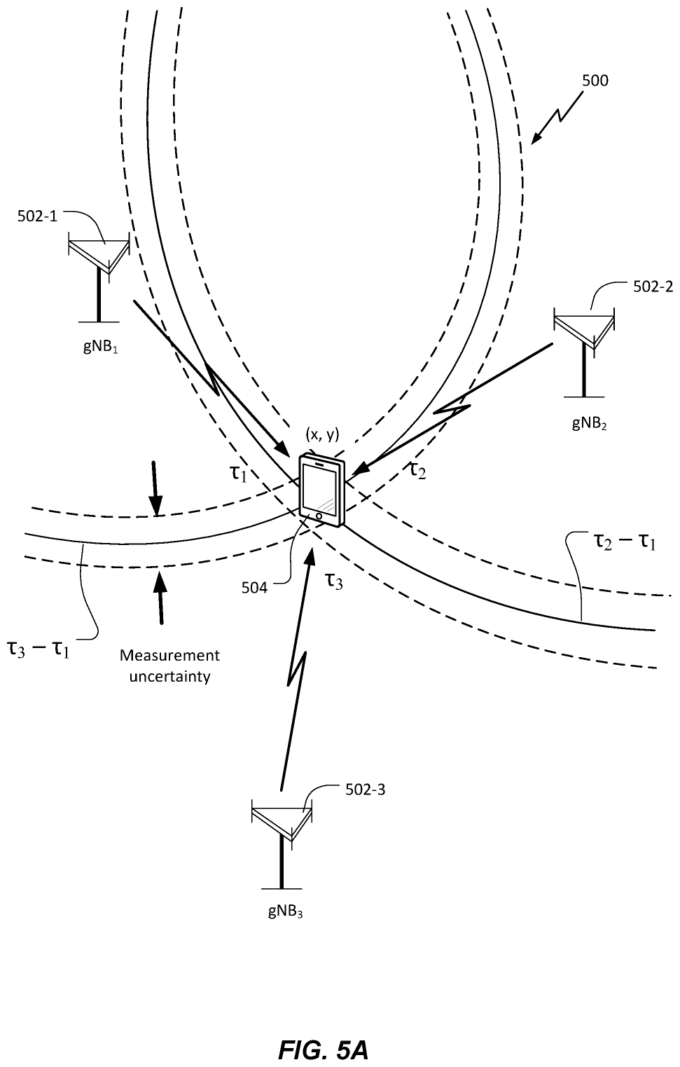

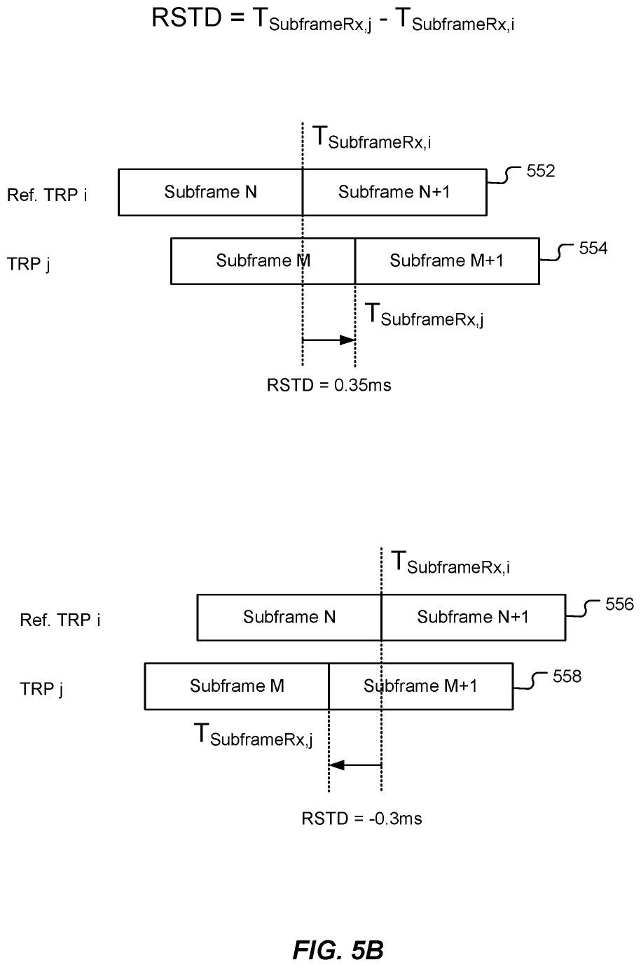

Referring to FIG. 5A, an exemplary wireless communications system 500 according to various aspects of the disclosure is shown. In the example of FIG. 5A, a UE 504, which may correspond to any of the UEs described herein, is attempting to calculate an estimate of its position, or assist another entity (e.g., a base station or core network component, another UE, a location server, a third party application, etc.) to calculate an estimate of its position. The UE 504 may communicate wirelessly with a plurality of base stations 502-1, 502-2, and 502-3 which may correspond to any combination of the base stations described herein, using RF signals and standardized protocols for the modulation of the RF signals and the exchange of information packets. By extracting different types of information from the exchanged RF signals, and utilizing the layout of the wireless communications system 500 (e.g., the base stations locations, orientation of the antennas, geometry, etc.), the UE 504 may determine its position, or assist in the determination of its position, in a predefined reference coordinate system. In an aspect, the UE 504 may specify its position using a two-dimensional (2D) coordinate system; however, the aspects disclosed herein are not so limited, and may also be applicable to determining positions using a three-dimensional (3D) coordinate system, if the extra dimension is desired. Additionally, while FIG. 5A illustrates one UE 504 and three base stations 502-1, 502-2, 502-3, as will be appreciated, there may be more UEs 504 and more or fewer base stations.

To support position estimates, the base stations 502-1, 502-2, 502-3 may be configured to broadcast positioning reference signals (e.g., PRS, NRS, TRS, CRS, etc.) to UEs in their coverage area to enable a UE 504 to measure characteristics of such reference signals. For example, the observed time difference of arrival (OTDOA) positioning method is a multilateration method in which the UE 504 measures the time difference, known as a reference signal time difference (RSTD), between specific reference signals (e.g., PRS, CRS, CSI-RS, etc.) transmitted by different pairs of network nodes (e.g., base stations, antennas of base stations, etc.) and either reports these time differences to a location server, such as the server 400 (e.g., the LMF 120), or computes a location estimate itself from these time differences.

Generally, RSTDs are measured between a reference network node (e.g., base station 502-1 in the example of FIG. 5A) and one or more neighbor network nodes (e.g., base stations 502-2 and 502-3 in the example of FIG. 5A). The reference network node remains the same for all RSTDs measured by the UE 504 for any single positioning use of OTDOA and would typically correspond to the serving cell for the UE 504 or another nearby cell with good signal strength at the UE 504. In an aspect, where a measured network node is a cell supported by a base station, the neighbor network nodes would normally be cells supported by base stations different from the base station for the reference cell and may have good or poor signal strength at the UE 504. The location computation can be based on the measured time differences (e.g., RSTDs) and knowledge of the network nodes' locations and relative transmission timing (e.g., regarding whether network nodes are accurately synchronized or whether each network node transmits with some known time difference relative to other network nodes).

To assist positioning operations, a location server (e.g., server 400, LMF 120) may provide OTDOA assistance data to the UE 504 for the reference network node (e.g., base station 502-1 in the example of FIG. 5A) and the neighbor network nodes (e.g., base stations 502-2 and 502-3 in the example of FIG. 5A) relative to the reference network node. For example, the assistance data may provide the center channel frequency of each network node, various reference signal configuration parameters (e.g., the number of consecutive positioning subframes, periodicity of positioning subframes, muting sequence, frequency hopping sequence, reference signal identifier (ID), reference signal bandwidth), a network node global ID, and/or other cell related parameters applicable to OTDOA. The OTDOA assistance data may indicate the serving cell for the UE 504 as the reference network node.

In some cases, OTDOA assistance data may also include “expected RSTD” parameters, which provide the UE 504 with information about the RSTD values the UE 504 is expected to measure at its current location between the reference network node and each neighbor network node, together with an uncertainty of the expected RSTD parameter. The expected RSTD, together with the associated uncertainty, may define a search window for the UE 504 within which the UE 504 is expected to measure the RSTD value. OTDOA assistance information may also include reference signal configuration information parameters, which allow a UE 504 to determine when a reference signal positioning occasion occurs on signals received from various neighbor network nodes relative to reference signal positioning occasions for the reference network node, and to determine the reference signal sequence transmitted from various network nodes in order to measure a signal time of arrival (ToA) or RSTD.

In an aspect, while the location server (e.g., server 400, LMF 120) may send the assistance data to the UE 504, alternatively, the assistance data can originate directly from the network nodes (e.g., base stations 502) themselves (e.g., in periodically broadcasted overhead messages, etc.). Alternatively, the UE 504 can detect neighbor network nodes itself without the use of assistance data.

The UE 504 (e.g., based in part on the assistance data, if provided) can measure and (optionally) report the RSTDs between reference signals received from pairs of network nodes. Using the RSTD measurements, the known absolute or relative transmission timing of each network node, and the known position(s) of the transmitting antennas for the reference and neighboring network nodes, the network (e.g., server 400, LMF 120, a base station 502) or the UE 504 may estimate a position of the UE 504. More particularly, the RSTD for a neighbor network node “k” relative to a reference network node “Ref” may be given as (ToAk−ToARef), where the ToA values may be measured modulo one subframe duration (1 ms) to remove the effects of measuring different subframes at different times. In the example of FIG. 5A, the measured time differences between the reference cell of base station 502-1 and the cells of neighboring base stations 502-2 and 502-3 are represented as τ2−τ1 and τ3−τ1, where τ1, τ2, and τ3 represent the ToA of a reference signal from the transmitting antenna(s) of base station 502-1, 502-2, and 502-3, respectively. The UE 504 may then convert the ToA measurements for different network nodes to RSTD measurements and (optionally) send them to the server 400/LMF 120. Using (i) the RSTD measurements, (ii) the known absolute or relative transmission timing of each network node, (iii) the known position(s) of physical transmitting antennas for the reference and neighboring network nodes, and/or (iv) directional reference signal characteristics such as a direction of transmission, the UE's 504 position may be determined (either by the UE 504 or the server 400/LMF 120). In operation, the base stations 502-1, 502-1, 502-3 may be configured to transmit the PRS at different times. The difference between the transmission times (e.g., the transmission offsets) may be known and provided to and/or detected by the UE 504, and the UE 504 may be configured to determine the RSTD based in part on the transmission offsets.

Still referring to FIG. 5A, when the UE 504 obtains a location estimate using OTDOA measured time differences, the necessary additional data (e.g., the network nodes' locations and relative transmission timing) may be provided to the UE 504 by a location server (e.g., server 400, LMF 120). In some implementations, a location estimate for the UE 504 may be obtained (e.g., by the UE 504 itself or by the server 400/LMF 120) from OTDOA measured time differences and from other measurements made by the UE 504 (e.g., measurements of signal timing from global positioning system (GPS) or other global navigation satellite system (GNSS) satellites). In these implementations, known as hybrid positioning, the OTDOA measurements may contribute towards obtaining the UE's 504 location estimate but may not wholly determine the location estimate.

Uplink time difference of arrival (UTDOA) is a similar positioning method to OTDOA, but is based on uplink reference signals (e.g., sounding reference signals (SRS), uplink positioning reference signals (UL PRS), SRS for positioning signals) transmitted by the UE (e.g., UE 504). Further, transmission and/or reception beamforming at the base station 502-1, 502-2, 502-3 and/or UE 504 can enable wideband bandwidth at the cell edge for increased precision. Beam refinements may also leverage channel reciprocity procedures in 5G NR.

In NR, there is no requirement for precise timing synchronization across the network. Instead, it is sufficient to have coarse time-synchronization across gNBs (e.g., within a cyclic prefix (CP) duration of the OFDM symbols). Coarse timing synchronization is generally sufficient for Round-trip-time (RTT)-based methods, and the sidelink assisted methods described herein, and as such, are a practical positioning methods in NR.

Referring to FIG. 5B, a diagram of example RSTDs based on signals transmitted from two base stations is shown. The RSTD may be defined as the relative timing difference between a transmission point (TP) j and a reference TP i. For example, the UE 504 may receive a first signal 552 transmitted from a reference TRP i (e.g., the first base station 502-1) and a second signal 554 from a neighboring TRP j (e.g., the second base station 502-2). The signals 552, 554 may be organized into subframes in the time domain and the RSTD may be expressed as:

$$RSTD = {T}_{SubframeRx , j} - {T}_{subframeRx , i} \qquad ( 1 )$$

where,
T_{subframeRx,j} is the time when the UE 504 receives the start of one subframe from TP j; and
T_{subframeRx,i} is the time when the UE 504 receives the corresponding start of one subframe from TP i that is closest to the subframe from TP j.

Multiple PRS resources can be used to determine the start of one subframe from a TP. In an example, the duration of a subframe is 1 ms and thus the beginning of the nearest subframe of a neighbor TRP is at most +/−0.5 ms away from the beginning of a subframe of a reference TRP. The current reporting range of an RSTD measurement is between −0.5 ms and 0.5 ms (i.e., for a subframe duration of 1 ms. Other ranges may be used for other subframe durations). Examples of determining the closest start of a subframe are depicted in FIG. 5B. In a first example, the RSTD between the first and second signals 552, 554 is 0.35 ms. In a second example, the RSTD between a third signal 556 and a fourth signal 558 is −0.3 ms.

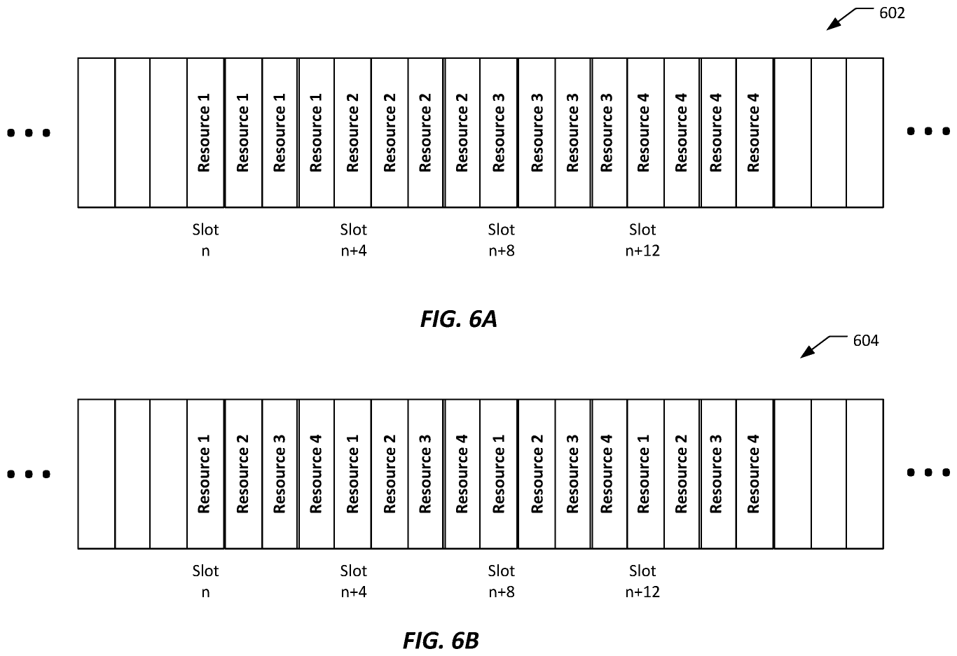

Referring to FIGS. 6A and 6B, example downlink PRS resource sets are shown. In general, a PRS resource set is a collection of PRS resources across one base station (e.g., TRP 300) which have the same periodicity, a common muting pattern configuration and the same repetition factor across slots. A first PRS resource set 602 includes 4 resources and a repetition factor of 4, with a time-gap equal to 1 slot. A second PRS resource set 604 includes 4 resources and a repetition factor of 4 with a time-gap equal to 4 slots. The repetition factor indicates the number of times each PRS resource is repeated in each single instance of the PRS resource set (e.g., values of 1, 2, 4, 6, 8, 16, 32). The time-gap represents the offset in units of slots between two repeated instances of a PRS resource corresponding to the same PRS resource ID within a single instance of the PRS resource set (e.g., values of 1, 2, 4, 8, 16, 32). The time duration spanned by one PRS resource set containing repeated PRS resources does not exceed PRS-periodicity. The repetition of a PRS resource enables receiver beam sweeping across repetitions and combining RF gains to increase coverage. The repetition may also enable intra-instance muting. A single instance of a PRS Resource Set as shown in FIG. 6A and FIG. 6B may also be referred to as a “PRS occasion”.

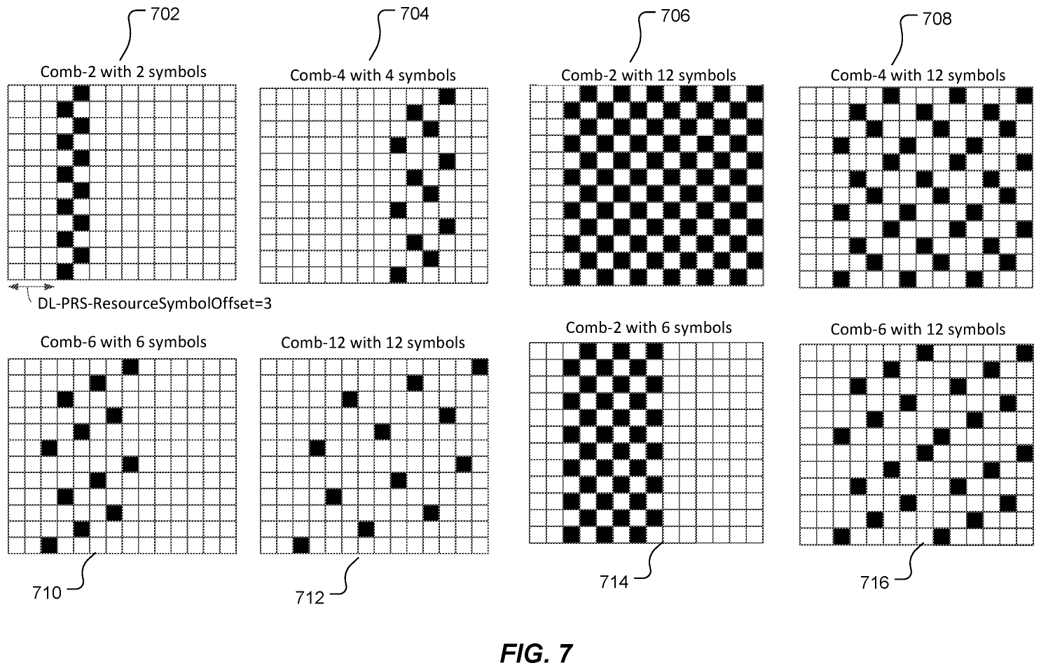

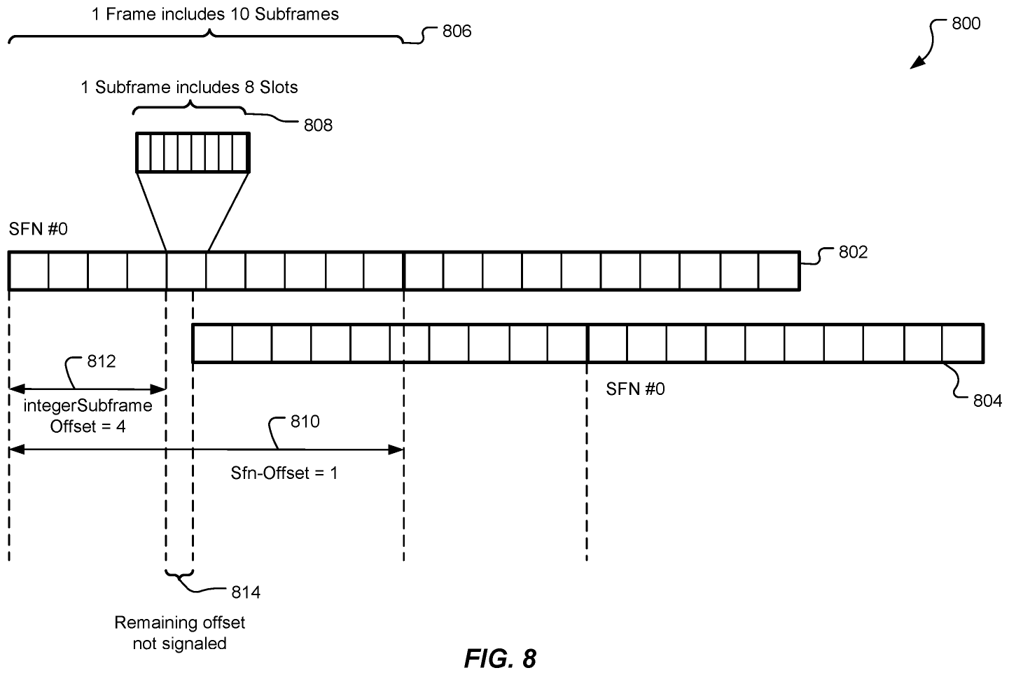

Referring to FIG. 7, example subframe and slot formats for positioning reference signal transmissions are shown. The example subframe and slot formats are included in the PRS resource sets depicted in FIGS. 6A and 6B. The subframes and slot formats in FIG. 7 are examples and not limitations and include a comb-2 with 2 symbols format 702, a comb-4 with 4 symbols format 704, a comb-2 with 12 symbols format 706, a comb-4 with 12 symbols format 708, a comb-6 with 6 symbols format 710, a comb-12 with 12 symbols format 712, a comb-2 with 6 symbols format 714, and a comb-6 with 12 symbols format 716. In general, a subframe may include 14 symbol periods with indices 0 to 13. Typically, a base station may transmit the PRS from antenna port 5000 on one or more slots in each subframe configured for PRS transmission.

A base station may transmit the PRS over a particular PRS bandwidth, which may be configured by higher layers. A PRS Resource may be located anywhere in the frequency grid. A common reference point for the PRS may be defined as “PRS Point A”. The “PRS Point A” may serve as a common reference point for the PRS resource block grid and may be represented by an Absolute Radio Frequency Channel Number (ARFCN). The PRS Start Physical Resource Block (PRB) may then be defined as a frequency offset between PRS Point A and the lowest subcarrier of the lowest PRS resource block expressed in units of resource blocks. The base station may transmit the PRS on subcarriers spaced apart across the PRS bandwidth.

The base station may also transmit the PRS based on the parameters such as PRS periodicity, PRS Resource Set Slot Offset, PRS Resource Slot Offset, PRS Resource Repetition Factor and PRS Resource Time Gap. PRS periodicity is the periodicity at which the PRS Resource is transmitted in number of slots. The PRS periodicity may depend on the subcarrier spacing (SCS) and may be, for example, 2μ {4,5,8,10,16,20,32,40,64,80,160,320,640,1280,2560,5120,10240} slots, with m=0, 1, 2, 3 for SCS 15, 30, 60, and 120 kHz, respectively. PRS Resource Set Slot Offset defines the slot offset with respect to System Frame Number (SFN)/Slot Number zero of the TRP (i.e., defines the slot where the first PRS Resource of the PRS Resource Set occurs). PRS Resource Slot Offset defines the starting slot of the PRS Resource with respect to the corresponding PRS Resource Set Slot Offset. PRS Resource Repetition Factor defines how many times each PRS Resource is repeated for a single instance of the PRS Resource Set, and PRS Resource Time Gap defines the offset in number of slots between two repeated instances of a PRS Resource within a single instance of the PRS Resource Set, as described above.

A PRS Resource may be muted. Muting may be signaled using a bit-map to indicate which configured PRS Resources are transmitted with zero-power (i.e., muted). In one option, the muting bit map may have a length of {2, 4, 6, 8, 16, 32} bits and muting is applied on each transmission instance of a PRS Resource Set. Each bit in the bit map may correspond to a configurable number of consecutive instances of a PRS Resource Set. All PRS Resources within a PRS Resource Set instance may be muted (transmitted with zero power) if the corresponding bit in the bit map indicates a ‘0’. The number of consecutive instances may be controlled by the parameter PRS Muting-Bit Repetition Factor, which may have the values {1, 2, 4, 8}. In another option, muting may be applied on each repetition of each of the PRS Resources. Each bit in the bit map may correspond to a single repetition of the PRS Resource within an instance of a PRS Resource Set. The length of the bit map may then be equal to the PRS Resource Repetition Factor.

In general, the PRS resources depicted in FIGS. 6A and 6B may be a collection of resource elements that are used for transmission of PRS. The collection of resource elements can span multiple physical resource blocks (PRBs) in the frequency domain and N (e.g., 1 or more) consecutive symbol(s) within a slot in the time domain. In a given OFDM symbol, a PRS resource occupies consecutive PRBs. A PRS resource is described by at least the following parameters: PRS resource identifier (ID), sequence ID, comb size-N, resource element offset in the frequency domain, starting slot and starting symbol, number of symbols per PRS resource (i.e., the duration of the PRS resource), and QCL information (e.g., QCL with other DL reference signals). The comb size indicates the number of subcarriers in each symbol carrying PRS. For example, a comb-size of comb-4 means that every fourth subcarrier of a given symbol carries PRS.

A PRS resource set is a set of PRS resources used for the transmission of PRS signals, where each PRS resource has a PRS resource ID. In addition, the PRS resources in a PRS resource set are associated with the same transmission-reception point (e.g., a TRP 300). Each of the PRS resources in the PRS resource set may have the same periodicity, a common muting pattern, and the same repetition factor across slots. A PRS resource set is identified by a PRS resource set ID and may be associated with a particular TRP (identified by a cell ID) transmitted by an antenna panel of a base station. A PRS resource ID in a PRS resource set may be associated with an omnidirectional signal, and/or with a single beam (and/or beam ID) transmitted from a single base station (where a base station may transmit one or more beams). Each PRS resource of a PRS resource set may be transmitted on a different beam and as such, a PRS resource, or simply resource can also be referred to as a beam. Note that this does not have any implications on whether the base stations and the beams on which PRS are transmitted are known to the UE.

Referring to FIG. 8, an illustration 800 of example radio frequency (RF) signal transmissions organized into a plurality of subframes in the time domain is shown. In an example, a first signal 802 and a second signal 804 may be transmitted by two different base stations (e.g., two of the base stations described in FIG. 5A). A first station (e.g., reference station) may transmit the first signal 802, and a second station may transmit the second signal 804. The signals are organized into frames, subframes and slots in the time domain. The organization is an example, and not a limitation, as other time domain organization schemes may also be used. In an example, a frame 806 may include 10 subframes 808, and each subframe 808 may include 8 slots. The number of slots is an example, and not a limitation, as other RATs such as 5G-NR may have 1, 2, 4, 8 or 16 slots per subframe. The subframes 808 may be used to specify the timing offset between the first and second signals 802, 804. In an example, a system frame number (SFN)0 Offset field may be included in assistance data to specify the time offset of the SFN #0 slot #0 for a given TRP with respect to the SFN #0slot #0 of a reference TRP. The SFN0 Offset field may include additional subfields such as Sfn-Offset field 810 and an integerSubframe Offset field 812. The Sfn-Offset field 810 corresponds to the number of full radio frames counted from the beginning of a radio frame #0 of the assistance data reference TRP to the beginning of the closest subsequent radio frame #0 of a neighbor TRP. As indicated in the illustration 800, the Sfn-Offset value is 1 for the first and second signals 802, 804. The integerSubframe Offset field 812 is a value counted from the beginning of a subframe #0 of the assistance data reference TRP to the beginning of the closest subsequent subframe #0 of a neighbor TRP, rounded down to multiples of subframes. The integerSubframe Offset value is 4 for the first and second signals 802, 804. An issue with the SFN0 Offset field in the current specifications (e.g., 3GPP 37.355) is that a remaining offset value 814 is not signaled in the assistance data.

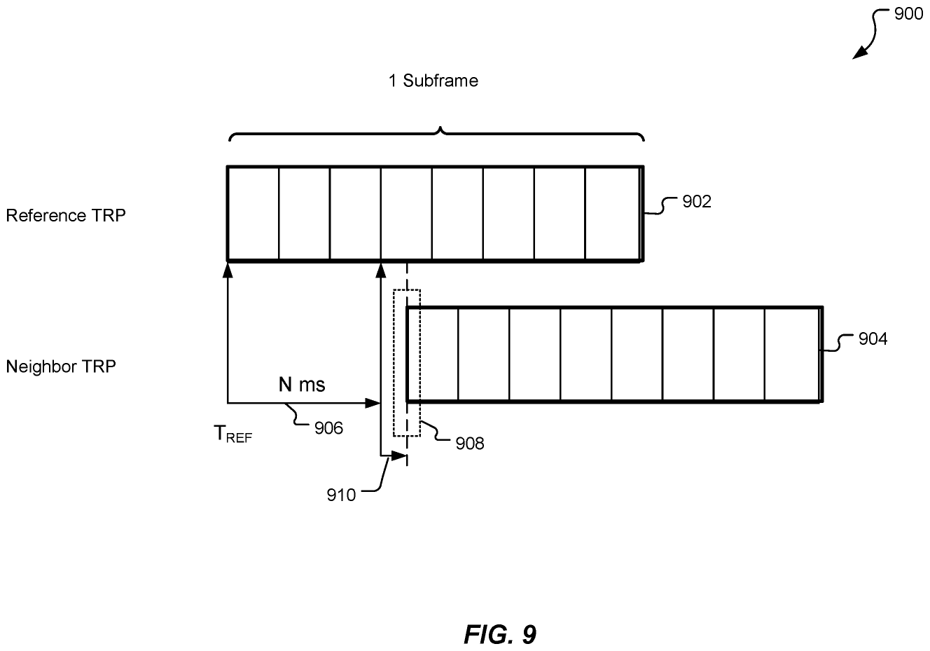

Referring to FIG. 9, a diagram 900 of an example PRS search window 908 is shown. The diagram 900 includes a first signal 902 transmitted from a reference TRP and a second signal 904 transmitted from a neighbor TRP. Eight subframes in each of the signals 902, 904 are depicted in FIG. 9 to facilitate the description of the search window computations. In operation, a target device may utilize the subframe structure and timing offset information to compute a search window for detecting PRS in the second signal 904. For example, a target device may assume that the beginning of the subframe for the PRS for the neighbor TRP is received within or proximate to the search window 908. The size of the search window 908 may vary based on the time domain organization. In an example, a subframe in the diagram 900 represents 1 ms of time. In an example, the computation for determining the center of the search window 908 may be expressed as:

$${T}_{REF} + 1 ms * N + ExpectedRSTD * 4 * Ts \qquad ( 2 )$$

where,
T_{REF} is the reception time of the beginning of the subframe for the PRS of the reference TRP at the target device antenna connector;

$$Ts = 1 / ( 15000 * 2048 ) seconds ;$$

and
ExpectedRSTD is the expected RSTD is computed by the network based on a rough location of the target station and provided in assistance data (e.g., nr DL-PRS-ExpectedRSTD).
   The value ‘N’ may be computed based on the following equation:

$$N = 10 * Sfn - Offset + integerSubframe Offset + {subframeNum}_{j} - {subframeNum}_{i} \qquad ( 3 )$$

where,
subframeNumᵢ(subframeNumⱼ) correspond to the subframe number of PRS from TRP i(j).

Information elements in the assistance data, such as the dl-PRS-Periodicity-and-ResourceSetSlotOffset and dl-PRS-ResourceSlotOffset are used to determine the frame, subframe and slot number of the PRS resource under consideration. In an example, the maximum ExpectedRSTD is 0.5 ms (e.g., 3841*4*Ts). The width of the search window 908 may be based on an uncertainty value associated with the ExpectedRSTD provided by the network. The width of the search window 908 may be based on adding and subtracting an network provided uncertainty value to the center of the search window. In an example, a nr-DL-PRS-ExpectedRSTD-Uncertainty may be included in the assistance data. As depicted in FIG. 9, the center of the search window 908 may be based on adding the N value 906 and the ExpectedRSTD value 910 to the T_{REF}.

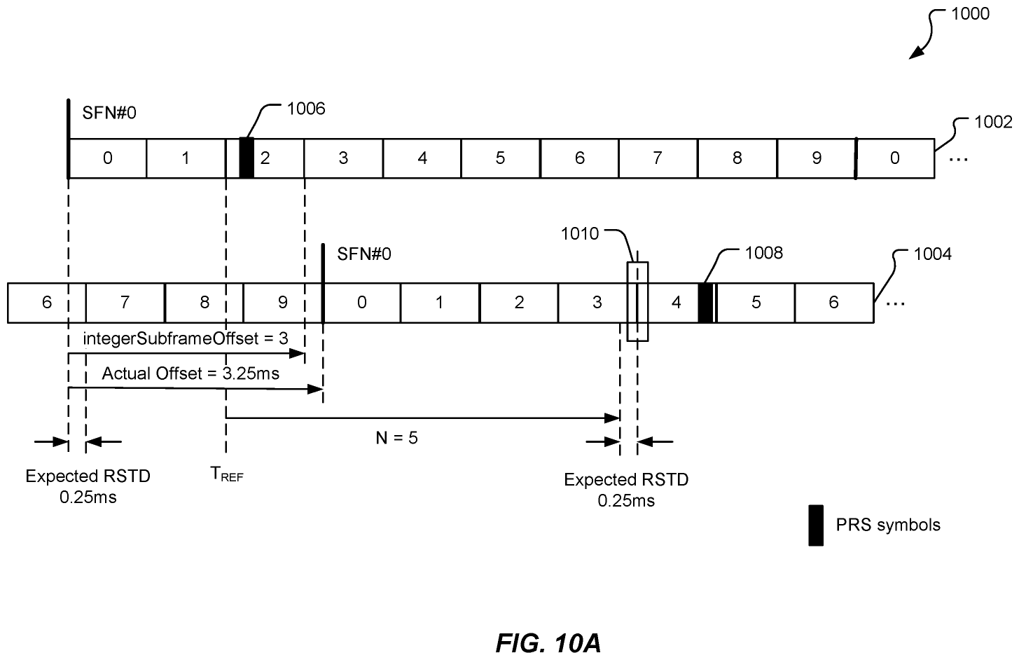

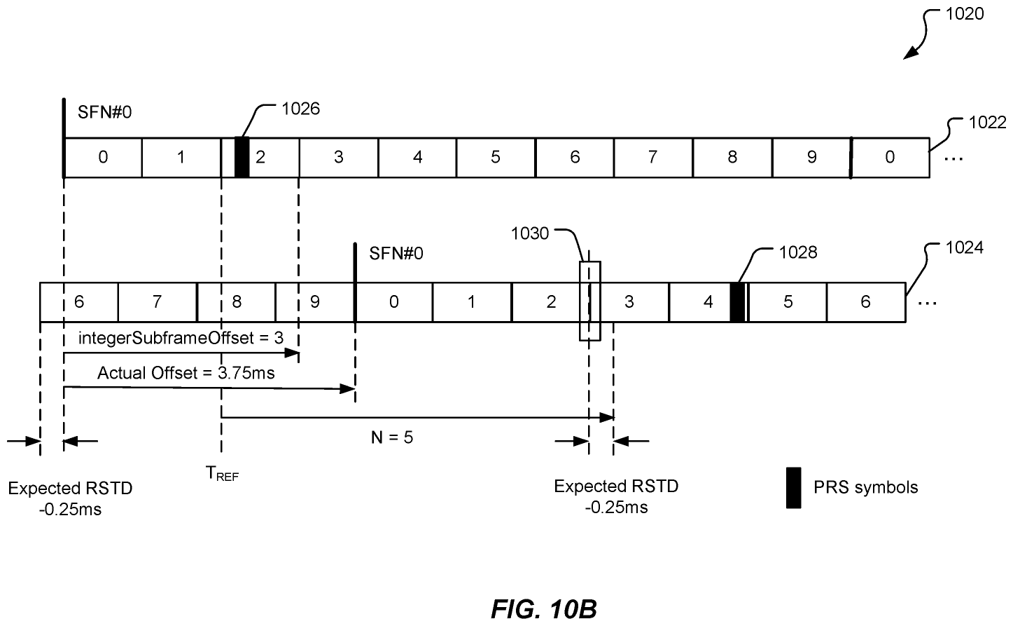

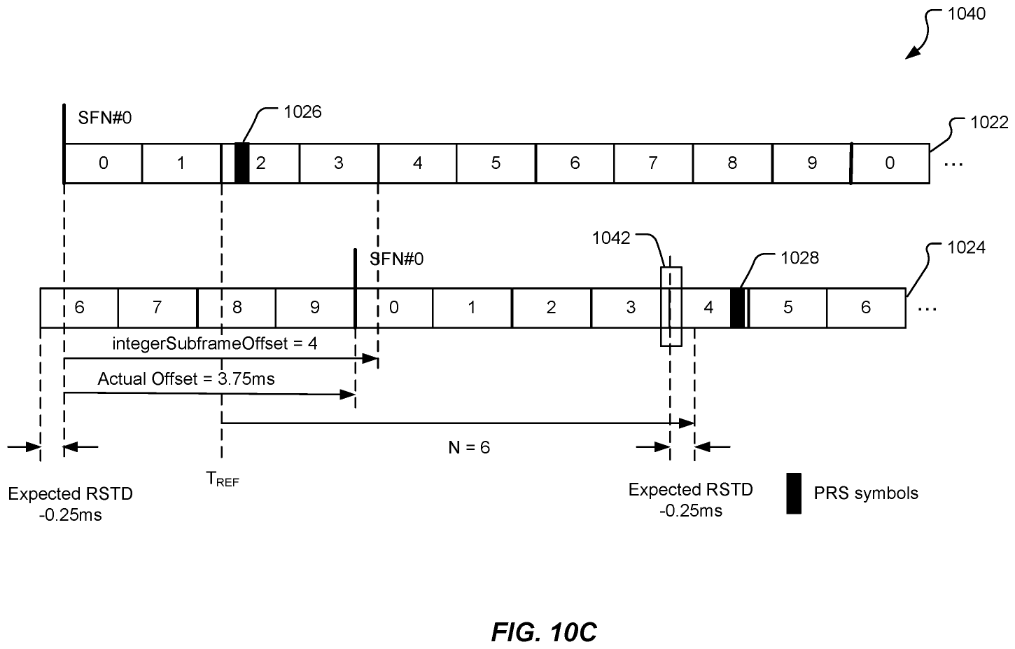

Referring to FIGS. 10A-10C, example use cases for determining positioning reference signal search windows are shown. Each of the use cases includes two RF signals containing PRS transmitted from two different stations that are equidistant from the receiving UE. Since the transmitting stations are at equal distances from the receiving station, the transmission offset is equal to the reception offset. The use cases highlight the issue when a subframe offset value is rounded down to a multiple of the subframes. Referring to FIG. 10A, a first use case 1000 has a factional portion of the offset that is less than 0.5 ms (e.g., when the subframe duration is 1.0 ms). A first signal 1002 transmitted by a reference TRP includes a first PRS 1006 in the second subframe (i.e., subframeNumᵢ=2). A second signal 1004 transmitted by a neighboring TRP includes a second PRS 1008 in the fourth subframe (i.e. subframeNumⱼ=4). The PRS 1006, 1008 may be based on the PRS slot formats depicted in FIG. 7, or based on other reference signal configurations. The actual offset between the first and second signals 1002, 1004 in this example is 3.25 ms, with an ExpectedRSTD of 0.25 ms. The Sfn-Offset is zero and the integerSubframeOffset is 3, since the value is rounded down to the nearest multiple of a subframe. Using equation (3) above, the value of N is computed as:

$$N = 10 * [ 0 ] + [ 3 ] + [ 4 ] - [ 2 ] = 5 \qquad ( 4 )$$

This indicates that a search window 1010 is properly located at the subframe containing the second PRS 1008.

Referring to FIG. 10B, a second use case 1020 illustrates an issue in the PRS search window calculation when the fractional offset is above 0.5 ms (e.g., above half the duration of a subframe). A reference TRP transmits a first signal 1022 including a first PRS 1026 in the second subframe (i.e., subframeNumᵢ=2). A neighbor TRP transmits a second signal 1024 including a second PRS 1028 in the fourth subframe (i.e. subframeNumⱼ=4). The actual offset is 3.75 ms, which is defined per 3GPP 38.211 as an ExpectedRSTD=−0.25 ms (e.g., as described in FIG. 5B). The integerSubframe offset is equal to 3 because the 3.75 ms is rounded down to the nearest multiple of the subframes. The Sfn-Offset is zero. Thus, the value of N is also 5 based on equation 3. In this use case, however, the resulting PRS search window 1030 is in the wrong location. That is, as depicted in FIG. 10B, the search window is aligned with the third subframe, which is one subframe before the second PRS 1028. The rounding error caused by the definition of the integerSubframeOffset value decreases the probability that the receiving station will detect the second PRS 1028. Modifying the procedure for determining the integerSubframeOffset value may improve the search window computation results. For example, FIG. 10C illustrates a third use case 1040 based on the first and second signals 1022, 1024 described in FIG. 10B. In this use case, the integerSubframeOffset value is rounded to the nearest subframe multiple. The 0.75 ms is rounded up (instead of rounding down per the current procedures), thus the integerSubframe offset is equal to 4. This increases the N value to 6, which is used to locate a search window 1042 in the correct location (i.e., in the subframe with the second PRS 1028).

Network resources, such as the LMF 120, may be configured to perform the modification of the integerSuframeOffset procedure as described in FIG. 10C and provide the resulting information element to the UEs in assistance data. Utilizing such an integerSubframeOffset value, which has been rounded to the nearest number of multiples of subframes (e.g., as opposed to always rounding down) may be used to increase the accuracy of the location of a PRS search window. The modification, however, may require some adjustments to positioning computations performed by a UE in UE based positioning techniques.

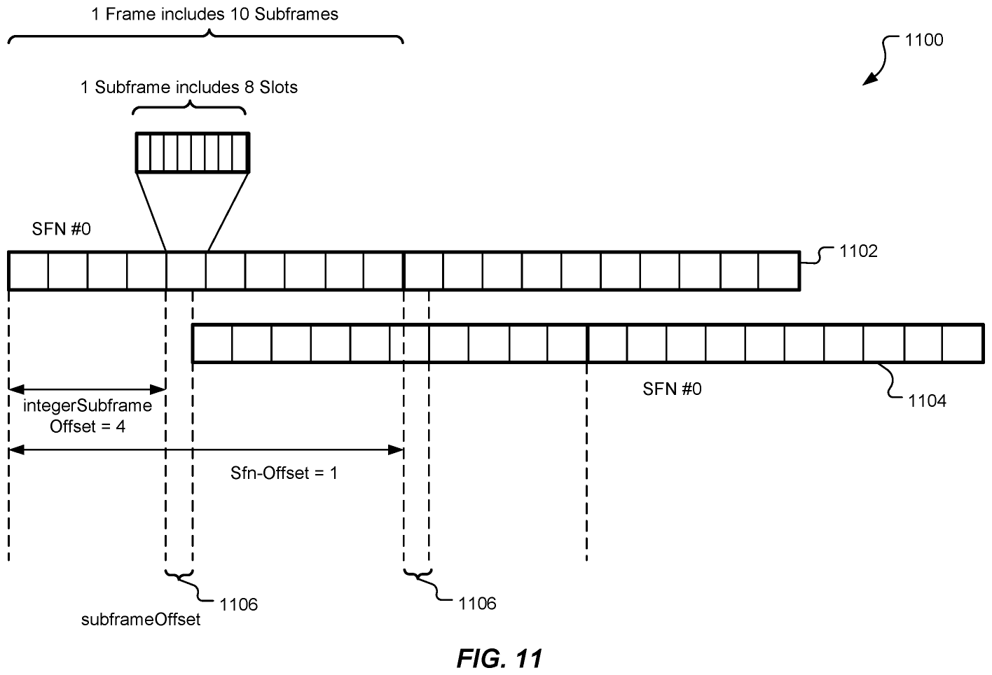

Referring to FIG. 11, a diagram 1100 of an example subframe offset value used for UE based positioning computations is shown. The diagram 1100 includes a first signal 1102 transmitted by a reference TRP, and a second signal 1104 transmitted by a neighboring TRP. The UE may be configured to receive a subframeOffset value 1106 in assistance data provided by a network. For example, a NR-RTD-Info object (e.g., per TS 37.355) may include a subframeOffset information element to specify the subframe boundary offset at the TRP antenna location between a reference TRP and a neighbor TRP in time units T_{c}=1/(Δfₘₐₓ*N_{f}) where Δfₘₐₓ=480*103 Hz, and N_{f}=4096 (e.g., TS 38.211). The offset is counted from the beginning of a subframe #0 of the reference TRP to the beginning of the closest subsequent subframe of a neighboring TRP. This fractional transmission offset is not currently used for computing a PRS search window. For example, a geometric RSTD value may be defined as the time difference in arrival at a UE if both TRPs transmitted the signals 1102, 1104 at the same time. When the TRPs are equidistant from the UE, the geometric RSTD should be zero. A computed RSTD (e.g., the difference between consecutive subframes) is the sum of both the transmission offset and the geometric RSTD (e.g., the RSTD due to the different locations of the TRPs) wrapped to [−0.5 ms, 0.5 ms]. To utilize the measured RSTD for positioning, the effect of the transmission offset must be subtracted. That is, the measured geometric RSTD is equal to the measured RSTD value minus the RTD-subframeOffset value. The UE may utilize the integerSubframeOffset value described in FIG. 10C for determining the measured RSTD, however, the resulting RSTD value may have to be wrapped to a value between −0.5 ms and 0.5 ms. Alternatively, the assistance data provided by the network may include one or more additional fields to indicate whether the integerSubframeOffset value was rounded up or rounded down.

In an example, the integerSubframeOffset may be defined as the offset counted from the beginning of a subframe #0 of a signal transmitted by reference TRP to the beginning of the closest subsequent subframe #0 of a signal transmitted by a neighboring TRP, rounded down to multiples of half subframes. The RSTD may still be defined in terms of the subframe. A parity (e.g., odd/even) of the number of half subframes may act as a flag for the computation of N. For example, a UE may be configured to compute N for the search window using the integerSubframeOffset as an integer when the number of half subframes is an even integer, or rounding up when the number of half subframes in an odd integer. The UE positioning computations may utilize the integerSubframeOffset as an integer (i.e., the rounded down value). In an example, an explicit flag (e.g., half-msOffset) may be set to 0 if the fractional part of the subframe offset is <0.5 ms, or set to 1 if the fractional part of the subframe offset is >0.5 ms. The UE may be configured to compute N for the search window using the integerSubframeOffset value if the flag is 0, or use the integerSubframeOffset value +1 if the flag is 1. UE based positioning uses just the integerSubframeOffset value regardless of the flag value.

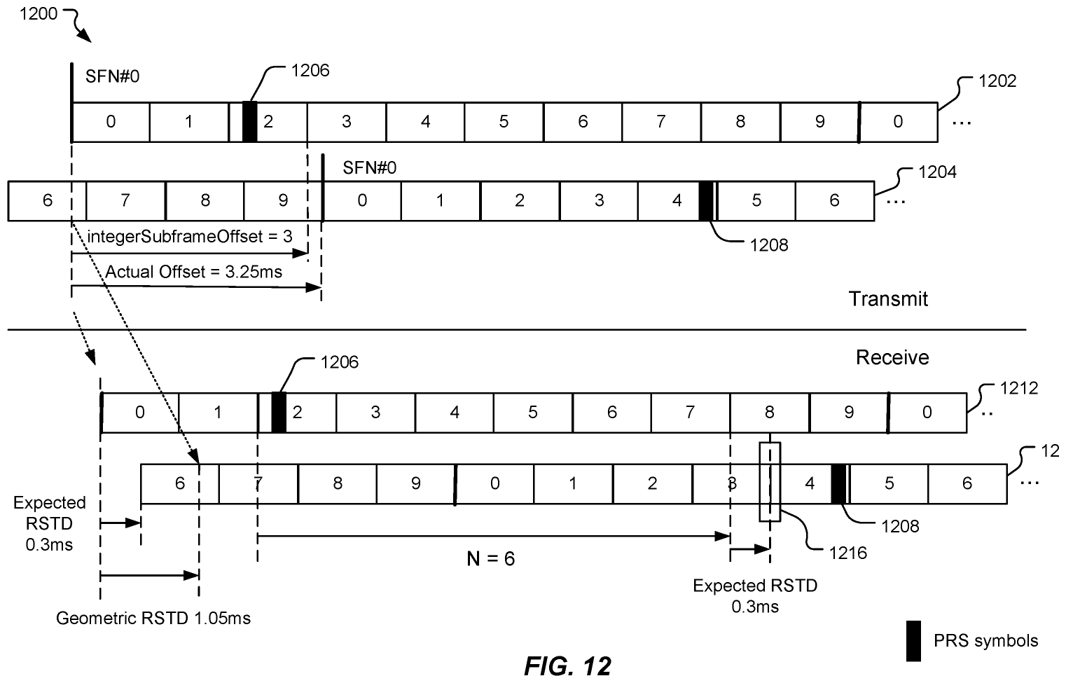

Referring to FIG. 12, a diagram 1200 of an example technique for determining a search window when a large reference signal time difference is detected is shown. The diagram 1200 includes two signals as they are transmitted by two TRPs and then received by a UE. A first transmitted signal 1202 including a first PRS 1206 in the second subframe is transmitted by a reference TRP. A second transmitted signal 1204 including a second PRS 1208 in the fourth subframe is transmitted by a neighboring TRP. A first receive signal 1212 is the first transmitted signal 1202 as received by a UE, and a second receive signal 1214 is the second transmitted signal 1204 as received by the UE. The expected RSTD value between the stations (as provided by the network) in this example is 0.3 ms. In reality, the geometric RSTD value at the UE is 1.05 ms as depicted in FIG. 12. The large geometric RSTD value can create issues for determining the location of a search window 1216 to detect and measure the second PRS 1208.

In an example, the assistance data provided to the UE from the network (e.g., the LMF 120) may include a new information element for determining the search window (e.g., a searchWindowOffset field). The searchWindowOffset field may indicate the excess value to be added to N when computing the location of a search window. For example, equation (3) may be modified to:

$$N = 10 * Sfn - Offset + integerSubframe Offset + searchWindowOffset + {subframeNum}_{j} - {subframeNum}_{i} \qquad ( 5 )$$

Utilizing equation (5) with the example in FIG. 12, the N value is 6, which accurately locates the search window 1216. The Expected RSTD relates transmission slot offset and UE reception slot offset within 1 subframe. The searchWindowOffset value along with the Expected RSTD relates the transmission slot offset and the reception slot offset completely and thus may be used when there are large geometric RSTD values. That is, the technique supports geometric RSTD values outside of the [−0.5 ms, 0.5 ms] range, which may be the case for certain non-terrestrial network (NTN) applications. The searchWindowOffset value may also include negative values. The geometric RSTD may be computed as the measured RSTD−RTDsubframeOffset+searchWindowOffset.

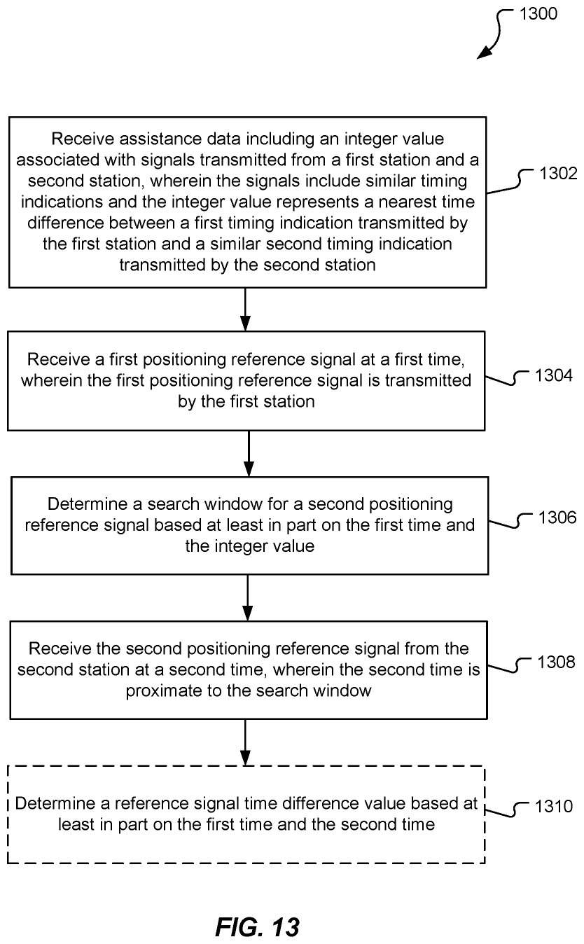

Referring to FIG. 13, with further reference to FIGS. 1-12, a method 1300 for determining a positioning reference signal search window includes the stages shown. The method 1300 is, however, an example and not limiting. The method 1300 may be altered, e.g., by having stages added, removed, rearranged, combined, performed concurrently, and/or having single stages split into multiple stages. For example, determining a RSTD value at stage 1310 is an optional process after determining a search window.

At stage 1302, the method includes receiving assistance data including an integer value associated with signals transmitted from a first station and a second station, wherein the signals include similar timing indications and the integer value represents a nearest time difference between a first timing indication transmitted by the first station and a similar second timing indication transmitted by the second station. A UE 200, including processors 210 and a transceiver 215, is a means for receiving the assistance data. In an example, NAS signaling techniques may be used to provide assistance data to a UE 200. The LMF 120 may provide assistance data via one or more LPP messages. Other signaling techniques, such as Radio Resource Control (RRC) and System Information Blocks (SIBs) may be used to provide assistance data to a UE. An example of the assistance data includes an nr-DL-PRS-SFN0-Offset field with an integerSubframeOffset field as the integer value associated with the signals transmitted from the first and second station. Referring to FIG. 10C, the first signal 1022 may be transmitted by a reference TRP and may include the first PRS 1026, and the second signal 1024 may be transmitted by a neighboring TRP, and may include the second PRS 1028. The UE 200 receives the assistance data including a integerSubframeOffset field representing the nearest time difference between a first timing indication transmitted by the reference TRP (e.g., a subframe indication of the first signal 1022) and a similar second timing indication transmitted by the neighbor TRP (e.g., the nearest subframe indication in the second signal 1024). As depicted in the example signals in FIG. 10C, the integerSubframeOffset is equal to 4.

At stage 1304, the method includes receiving a first positioning reference signal at a first time, wherein the first positioning reference signal is transmitted by the first station. The UE 200, including processors 210 and the transceiver 215, is a means for receiving the first PRS. The UE 200 may receive assistance data including center channel frequency of each network node, various reference signal configuration parameters (e.g., the number of consecutive positioning subframes, periodicity of positioning subframes, muting sequence, frequency hopping sequence, reference signal identifier (ID), reference signal bandwidth), a network node global ID, and/or other cell related parameters applicable to PRS measurements. The assistance data may indicate the serving cell for the UE 200 as the reference network node. The assistance data may also include “expected RSTD” parameters, which provide the UE 200 with information about the RSTD values the UE 200 is expected to measure at its current location between the reference network node and each neighbor network node, together with an uncertainty of the expected RSTD parameter. For example, referring to FIG. 10C, the UE 200 may locate and measure the first PRS 1026 based on the assistance data.

At stage 1306, the method includes determining a search window for a second positioning reference signal based at least in part on the first time and the integer value. The UE 200, including processors 210, is a means for determining the search window. In an example, the location of the search window is based on the Expected RSTD and N values based on the assistance data as described in equations (2) and (3). The UE may be configured to utilize the reception of the one or more PRS at stage 1304 (i.e., the first PRS may be received multiple times to improve the accuracy of the timing) to determine the relative location of the timing indications (e.g., SFN #0) in the first and second signals. The search window is associated with the subframe containing the second PRS and the UE may be configured to attempt to detect the second PRS based on the search window, rather than trying to find the second PRS using a broad search. The search window enables the UE 200 to conserve power and more efficiently measure other PRS based on the temporal location of the first PRS and the supporting assistance data.

At stage 1308, the method includes receiving the second positioning reference signal from the second station at a second time, wherein the second time is proximate to the search window. The UE 200, including processors 210 and the transceiver 215, is a means for receiving the second PRS. Referring to FIG. 10C, as an example, the UE 200 may compute the location of the search window 1042 at stage 1306, and then detect the second PRS 1028 at the second time. As used herein, the search window is proximate to the second time when it contains the start of the subframe containing the second PRS.

At stage 1310, the method optionally includes determining a reference signal time difference value based at least in part on the first time and the second time. The UE 200, including processors 210, is a means for determining a RSTD value. Determining an RSTD value for positioning is one application for using the search window described herein, however, the search window and/or corresponding reference signal measurements may be used for other purposes. For example, detecting reference signals for channel estimation and mobility applications. The RSTD may be based on equation (1) and it may be used to compute the hyperbolas as described in FIG. 5A.

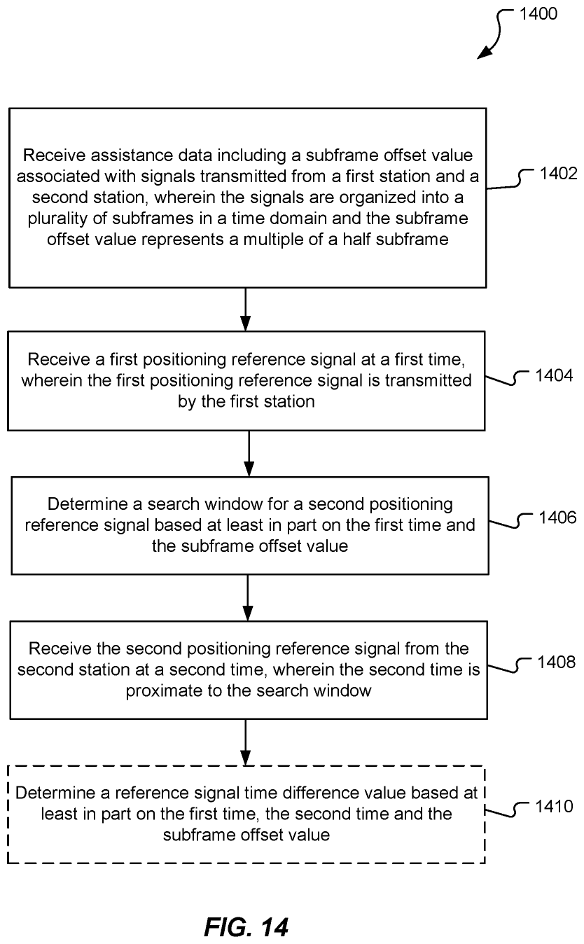

Referring to FIG. 14, with further reference to FIGS. 1-12, a method 1400 for determining a positioning reference signal search window includes the stages shown. The method 1400 is, however, an example and not limiting. The method 1400 may be altered, e.g., by having stages added, removed, rearranged, combined, performed concurrently, and/or having single stages split into multiple stages. For example, determining a RSTD value at stage 1410 is an optional process after determining a search window.

At stage 1402, the method includes receiving assistance data including a subframe offset value associated with signals transmitted from a first station and a second station, wherein the signals are organized into a plurality of subframes in a time domain and the subframe offset value represents a multiple of a half subframe. A UE 200, including processors 210 and a transceiver 215, is a means for receiving the assistance data. In an example, NAS signaling techniques may be used to provide assistance data to a UE 200. The LMF 120 may provide assistance data via one or more LPP messages. Other signaling techniques, such as RRC and SIBs may be used to provide assistance data to a UE. An example of the assistance data includes an nr-DL-PRS-SFN0-Offset field with an integerSubframeOffset field as the integer value associated with the signals transmitted from the first and second station. The integerSubframeOffset may be defined as the offset counted from the beginning of a subframe #0 of a signal transmitted by reference TRP to the beginning of the closest subsequent subframe #0 of a signal transmitted by a neighboring TRP, rounded down to multiples of half subframes. In an example, a parity (e.g., odd/even) of the number of half subframes may act as a flag for the computation of N. The UE 200 may be configured to compute N for the search window using the integerSubframeOffset as an even or odd integer (e.g., rounding up when an odd integer). The UE 200 may be configured to compute N for the search window using the integerSubframeOffset value if the flag is 0, or use the integerSubframeOffset value +1 if the flag is 1.

At stage 1404, the method includes receiving a first positioning reference signal at a first time, wherein the first positioning reference signal is transmitted by the first station. The UE 200, including processors 210 and the transceiver 215, is a means for receiving the first PRS. The UE 200 may receive assistance data including center channel frequency of each network node, various reference signal configuration parameters (e.g., the number of consecutive positioning subframes, periodicity of positioning subframes, muting sequence, frequency hopping sequence, reference signal identifier (ID), reference signal bandwidth), a network node global ID, and/or other cell related parameters applicable to PRS measurements. The assistance data may indicate the serving cell for the UE 200 as the reference network node. The assistance data may also include “expected RSTD” parameters, which provide the UE 200 with information about the RSTD values the UE 200 is expected to measure at its current location between the reference network node and each neighbor network node, together with an uncertainty of the expected RSTD parameter. For example, referring to FIG. 10C, the UE 200 may locate and measure the first PRS 1026 based on the assistance data.

At stage 1406, the method includes determining a search window for a second positioning reference signal based at least in part on the first time and the subframe offset value. The UE 200, including processors 210, is a means for determining the search window. In an example, the location of the search window is based on the Expected RSTD and N values based on the assistance data as described in equations (2) and (3), wherein the integerSubframeOffset value is rounded to the nearest half subframe. The UE may be configured to utilize the reception of the one or more PRS at stage 1404 (i.e., the first PRS may be received multiple times to improve the accuracy of the timing) to determine the relative location of timing indications (e.g., subframe #0) in the signals. The search window is associated with the subframe containing the second PRS and the UE may be configured to attempt to detect the second PRS based on the search window, rather than trying to find the second PRS using a broad search.

At stage 1408, the method includes receiving the second positioning reference signal from the second station at a second time, wherein the second time is proximate to the search window. The UE 200, including processors 210 and the transceiver 215, is a means for receiving the second PRS. Referring to FIG. 10C, as an example, the UE 200 may compute the location of the search window 1042 at stage 1406, and then detect the second PRS 1028 at the second time. As used herein, the search window is proximate to the second time when it contains the start of the subframe containing the second PRS.

At stage 1410, the method optionally includes determining a reference signal time difference value based at least in part on the first time, the second time, and the subframe offset value. The UE 200, including processors 210, is a means for determining a RSTD value. Determining an RSTD value for positioning is one application for using the search window described herein, however, the search window and/or corresponding reference signal measurements may be used for other purposes. For example, detecting reference signals for channel estimation and mobility applications. The RSTD may be based on equation (1) and it may be used to compute the hyperbolas as described in FIG. 5A. The UE positioning computations may utilize the integerSubframeOffset as an integer (i.e., without rounding) when the RSTD is an integer or a non-integer (e.g., whole or half subframe value). In an example, an explicit flag (e.g., half-msOffset) may be set to 0 if the fractional part of the subframe offset is <0.5 ms, or set to 1 if the fractional part of the subframe offset is >0.5 ms. The UE may be configured to compute N for the search window using the integerSubframeOffset value if the flag is 0, or use the integerSubframeOffset value +1 if the flag is 1, and the UE based positioning uses just the integerSubframeOffset value regardless of the flag value.

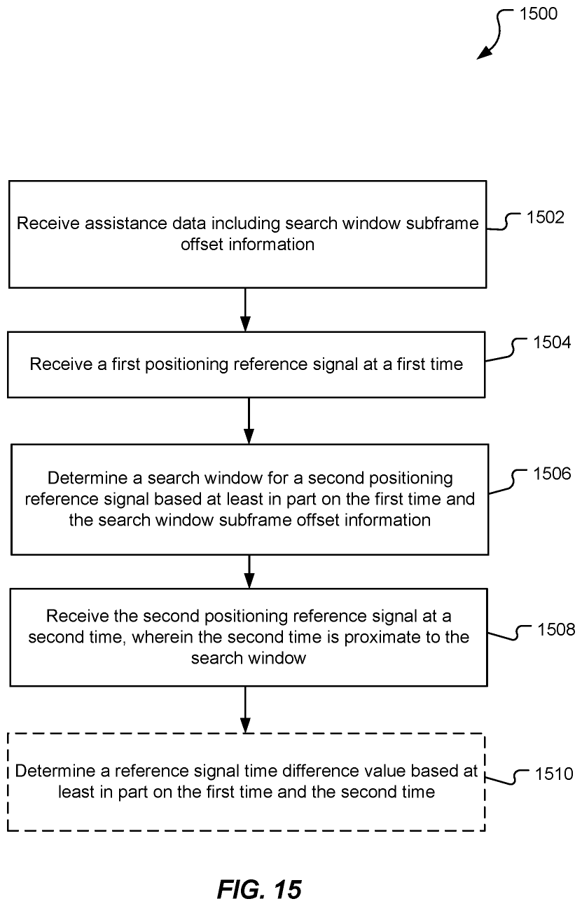

Referring to FIG. 15, with further reference to FIGS. 1-12, a method 1500 for determining a positioning reference signal search window includes the stages shown. The method 1500 is, however, an example and not limiting. The method 1500 may be altered, e.g., by having stages added, removed, rearranged, combined, performed concurrently, and/or having single stages split into multiple stages. For example, determining a RSTD value at stage 1510 is an optional process after determining a search window.

At stage 1502, the method includes receiving assistance data including search window subframe offset information. A UE 200, including processors 210 and a transceiver 215, is a means for receiving the assistance data. In an example, NAS signaling techniques may be used to provide assistance data to a UE 200. The LMF 120 may provide assistance data via one or more LPP messages. Other signaling techniques, such as RRC and SIBs may be used to provide assistance data to a UE. In an example, the assistance data provided to the UE from the network (e.g., the LMF 120) may include the search window subframe information as a new information element (e.g., a searchWindowOffset field). The searchWindowOffset field may indicate the excess value to be added to N when computing the location of a search window.

At stage 1504, the method includes receiving a first positioning reference signal at a first time. The UE 200, including processors 210 and the transceiver 215, is a means for receiving the first PRS. The UE 200 may receive assistance data including center channel frequency of each network node, various reference signal configuration parameters (e.g., the number of consecutive positioning subframes, periodicity of positioning subframes, muting sequence, frequency hopping sequence, reference signal identifier (ID), reference signal bandwidth), a network node global ID, and/or other cell related parameters applicable to PRS measurements. The assistance data may indicate the serving cell for the UE 200 as the reference network node. The assistance data may also include “expected RSTD” parameters, which provide the UE 200 with information about the RSTD values the UE 200 is expected to measure at its current location between the reference network node and each neighbor network node, together with an uncertainty of the expected RSTD parameter. For example, referring to FIG. 12, the UE 200 may locate and measure the first PRS 1206 based in part on the assistance data.

At stage 1506, the method includes determining a search window for a second positioning reference signal based at least in part on the first time and the search window subframe information. The UE 200, including processors 210, is a means for determining the search window. In an example, the location of the search window is based on the Expected RSTD and N values based on the assistance data and the search window subframe information (i.e., the searchWindowOffset field) as described in equations (2) and (5). The UE may be configured to utilize the reception of the one or more PRS at stage 1504 (i.e., the first PRS may be received multiple times to improve the accuracy of the timing) to determine the relative location of timing indications (e.g., SFN #0) in the first and second signals. The search window subframe information (i.e., the searchWindowOffset value) along with the Expected RSTD relates the transmission slot offset and the reception slot offset completely and thus may be used when there are large geometric RSTD values. That is, the technique supports geometric RSTD values outside of the [−0.5 ms, 0.5 ms] range, which may be the case for certain NTN applications.

At stage 1508, the method includes receiving the second positioning reference signal at a second time, wherein the second time is proximate to the search window. The UE 200, including processors 210 and the transceiver 215, is a means for receiving the second PRS. Referring to FIG. 12, as an example, the UE 200 may compute the location of the search window 1216 at stage 1506, and then detect the second PRS 1208 at the second time. As used herein, the search window is proximate to the second time when it contains the start of the subframe containing the second PRS.

At stage 1510, the method optionally includes determining a reference signal time difference value based at least in part on the first time and the second time. The UE 200, including processors 210, is a means for determining a RSTD value. Determining an RSTD value for positioning is one application for using the search window described herein, however, the search window and/or corresponding reference signal measurements may be used for other purposes. For example, detecting reference signals for channel estimation and mobility applications. The RSTD may be based on equation (1) and it may be used to compute the hyperbolas as described in FIG. 5A.

While the use cases and methods described herein utilize 5G-NR technologies, other radio access technologies may also be used. For example, determining a search window for reference signal measurements may apply to LTE, WiFi, Bluetooth, V2X, sidelink, and UWB based systems.

Other examples and implementations are within the scope of the disclosure and appended claims. For example, due to the nature of software and computers, functions described above can be implemented using software executed by a processor, hardware, firmware, hardwiring, or a combination of any of these. Features implementing functions may also be physically located at various positions, including being distributed such that portions of functions are implemented at different physical locations.

As used herein, the singular forms “a,” “an,” and “the” include the plural forms as well, unless the context clearly indicates otherwise. The terms “comprises,” “comprising,” “includes,” and/or “including,” as used herein, specify the presence of stated features, integers, steps, operations, elements, and/or components, but do not preclude the presence or addition of one or more other features, integers, steps, operations, elements, components, and/or groups thereof.

As used herein, the term RS (reference signal) may refer to one or more reference signals and may apply, as appropriate, to any form of the term RS, e.g., PRS, SRS, CSI-RS, etc.

As used herein, unless otherwise stated, a statement that a function or operation is “based on” an item or condition means that the function or operation is based on the stated item or condition and may be based on one or more items and/or conditions in addition to the stated item or condition.

Also, as used herein, “or” as used in a list of items prefaced by “at least one of” or prefaced by “one or more of” indicates a disjunctive list such that, for example, a list of “at least one of A, B, or C,” or a list of “one or more of A, B, or C” means A, or B, or C, or AB (A and B), or AC (A and C), or BC (B and C), or ABC (i.e., A and B and C), or combinations with more than one feature (e.g., AA, AAB, ABBC, etc.). Thus, a recitation that an item, e.g., a processor, is configured to perform a function regarding at least one of A or B means that the item may be configured to perform the function regarding A, or may be configured to perform the function regarding B, or may be configured to perform the function regarding A and B. For example, a phrase of “a processor configured to measure at least one of A or B” means that the processor may be configured to measure A (and may or may not be configured to measure B), or may be configured to measure B (and may or may not be configured to measure A), or may be configured to measure A and measure B (and may be configured to select which, or both, of A and B to measure). Similarly, a recitation of a means for measuring at least one of A or B includes means for measuring A (which may or may not be able to measure B), or means for measuring B (and may or may not be configured to measure A), or means for measuring A and B (which may be able to select which, or both, of A and B to measure). As another example, a recitation that an item, e.g., a processor, is configured to at least one of perform function X or perform function Y means that the item may be configured to perform the function X, or may be configured to perform the function Y, or may be configured to perform the function X and to perform the function Y. For example, a phrase of “a processor configured to at least one of measure X or measure Y” means that the processor may be configured to measure X (and may or may not be configured to measure Y), or may be configured to measure Y (and may or may not be configured to measure X), or may be configured to measure X and to measure Y (and may be configured to select which, or both, of X and Y to measure).

Substantial variations may be made in accordance with specific requirements. For example, customized hardware might also be used, and/or particular elements might be implemented in hardware, software (including portable software, such as applets, etc.) executed by a processor, or both. Further, connection to other computing devices such as network input/output devices may be employed. Components, functional or otherwise, shown in the figures and/or discussed herein as being connected or communicating with each other are communicatively coupled unless otherwise noted. That is, they may be directly or indirectly connected to enable communication between them.

The systems and devices discussed above are examples. Various configurations may omit, substitute, or add various procedures or components as appropriate. For instance, features described with respect to certain configurations may be combined in various other configurations. Different aspects and elements of the configurations may be combined in a similar manner. Also, technology evolves and, thus, many of the elements are examples and do not limit the scope of the disclosure or claims.

A wireless communication system is one in which communications are conveyed wirelessly, i.e., by electromagnetic and/or acoustic waves propagating through atmospheric space rather than through a wire or other physical connection. A wireless communication network may not have all communications transmitted wirelessly, but is configured to have at least some communications transmitted wirelessly. Further, the term “wireless communication device,” or similar term, does not require that the functionality of the device is exclusively, or even primarily, for communication, or that the device be a mobile device, but indicates that the device includes wireless communication capability (one-way or two-way), e.g., includes at least one radio (each radio being part of a transmitter, receiver, or transceiver) for wireless communication.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations, and does not limit the scope, applicability, or configurations of the claims. Rather, the preceding description of the configurations provides a description for implementing described techniques. Various changes may be made in the function and arrangement of elements.

The terms “processor-readable medium,” “machine-readable medium,” and “computer-readable medium,” as used herein, refer to any medium that participates in providing data that causes a machine to operate in a specific fashion. Using a computing platform, various processor-readable media might be involved in providing instructions/code to processor(s) for execution and/or might be used to store and/or carry such instructions/code (e.g., as signals). In many implementations, a processor-readable medium is a physical and/or tangible storage medium. Such a medium may take many forms, including but not limited to, non-volatile media and volatile media. Non-volatile media include, for example, optical and/or magnetic disks. Volatile media include, without limitation, dynamic memory.

Having described several example configurations, various modifications, alternative constructions, and equivalents may be used. For example, the above elements may be components of a larger system, wherein other rules may take precedence over or otherwise modify the application of the disclosure. Also, a number of operations may be undertaken before, during, or after the above elements are considered. Accordingly, the above description does not bound the scope of the claims.

A statement that a value exceeds (or is more than or above) a first threshold value is equivalent to a statement that the value meets or exceeds a second threshold value that is slightly greater than the first threshold value, e.g., the second threshold value being one value higher than the first threshold value in the resolution of a computing system. A statement that a value is less than (or is within or below) a first threshold value is equivalent to a statement that the value is less than or equal to a second threshold value that is slightly lower than the first threshold value, e.g., the second threshold value being one value lower than the first threshold value in the resolution of a computing system.

Implementation examples are described in the following numbered clauses:

Clause 1. A method for determining a positioning reference signal search window, comprising: receiving assistance data including an integer value associated with signals transmitted from a first station and a second station, wherein the signals include similar timing indications and the integer value represents a nearest time difference between a first timing indication transmitted by the first station and a similar second timing indication transmitted by the second station; receiving a first positioning reference signal at a first time, wherein the first positioning reference signal is transmitted by the first station; determining a search window for a second positioning reference signal based at least in part on the first time and the integer value; and receiving the second positioning reference signal from the second station at a second time, wherein the second time is proximate to the search window.

Clause 2. The method of clause 1 wherein the first timing indication and the similar second timing indication are a system subframe number.

Clause 3. The method of clause 1 wherein the assistance data includes an expected reference signal time difference value and an associated uncertainty value.

Clause 4. The method of clause 3 wherein a duration of the search window is based at least in part on the associated uncertainty value.

Clause 5. The method of clause 1 further comprising determining a reference signal time difference value based at least in part on the first time and the second time.

Clause 6. The method of clause 1 wherein the assistance data is received from a location management function via one or more LPP messages.

Clause 7. A method for determining a positioning reference signal search window, comprising: receiving assistance data including a subframe offset value associated with signals transmitted from a first station and a second station, wherein the signals are organized into a plurality of subframes in a time domain and the subframe offset value represents a multiple of a half subframe; receiving a first positioning reference signal at a first time, wherein the first positioning reference signal is transmitted by the first station; determining a search window for a second positioning reference signal based at least in part on the first time and the subframe offset value; and receiving the second positioning reference signal from the second station at a second time, wherein the second time is proximate to the search window.

Clause 8. The method of clause 7 wherein a location of the search window is based at least in part on a parity the subframe offset value, wherein the parity includes an odd subframe offset value or an even subframe offset value.

Clause 9. The method of clause 7 wherein the assistance data includes an expected reference signal time difference value and an associated uncertainty value.

Clause 10. The method of clause 9 wherein a duration of the search window is based at least in part on the associated uncertainty value.

Clause 11. The method of clause 7 further comprising determining a reference signal time difference value based at least in part on the first time and the second time.

Clause 12. The method of clause 7 wherein the assistance data is received from a location management function via one or more LPP messages.

Clause 13. A method for determining a positioning reference signal search window, comprising: receiving assistance data including search window subframe offset information; receiving a first positioning reference signal at a first time; determining a search window for a second positioning reference signal based at least in part on the first time and the search window subframe offset information; and receiving the second positioning reference signal at a second time, wherein the second time is proximate to the search window.

Clause 14. The method of clause 13 wherein the search window subframe offset information is an information element in the assistance data.

Clause 15. The method of clause 13 wherein the assistance data includes an expected reference signal time difference value and an associated uncertainty value.

Clause 16. The method of clause 15 wherein a duration of the search window is based at least in part on the associated uncertainty value.

Clause 17. The method of clause 13 further comprising determining a reference signal time difference value based at least in part on the first time and the second time.

Clause 18. The method of clause 13 wherein the assistance data is received from a location management function via one or more LPP messages.

Clause 19. The method of clause 13 wherein the assistance data is received via one or more system information blocks.

Clause 20. An apparatus, comprising: a memory; at least one transceiver; at least one processor communicatively coupled to the memory and the at least one transceiver, and configured to: receive assistance data including an integer value associated with signals transmitted from a first station and a second station, wherein the signals include similar timing indications and the integer value represents a nearest time difference between a first timing indication transmitted by the first station and a similar second timing indication transmitted by the second station; receive a first positioning reference signal at a first time, wherein the first positioning reference signal is transmitted by the first station; determine a search window for a second positioning reference signal based at least in part on the first time and the integer value; and receive the second positioning reference signal from the second station at a second time, wherein the second time is proximate to the search window.

Clause 21. The apparatus of clause 20 wherein the first timing indication and the similar second timing indication are a system subframe number.

Clause 22. The apparatus of clause 20 wherein the assistance data includes an expected reference signal time difference value and an associated uncertainty value.

Clause 23. The apparatus of clause 22 wherein the at least one processor is further configured to determine a duration of the search window based at least in part on the associated uncertainty value.

Clause 24. The apparatus of clause 20 wherein the at least one processor is further configured to determine a reference signal time difference value based at least in part on the first time and the second time.

Clause 25. The apparatus of clause 20 wherein the assistance data is received from a location management function via one or more LPP messages.

Clause 26. An apparatus, comprising: a memory; at least one transceiver; at least one processor communicatively coupled to the memory and the at least one transceiver, and configured to: receive assistance data including a subframe offset value associated with signals transmitted from a first station and a second station, wherein the signals are organized into a plurality of subframes in a time domain and the subframe offset value represents a multiple of a half subframe; receive a first positioning reference signal at a first time, wherein the first positioning reference signal is transmitted by the first station; determine a search window for a second positioning reference signal based at least in part on the first time and the subframe offset value; and receive the second positioning reference signal from the second station at a second time, wherein the second time is proximate to the search window.

Clause 27. The apparatus of clause 26 wherein a location of the search window is based at least in part on a parity the subframe offset value, wherein the parity includes an odd subframe offset value or an even subframe offset value.

Clause 28. The apparatus of clause 26 wherein the assistance data includes an expected reference signal time difference value and an associated uncertainty value.

Clause 29. The apparatus of clause 28 wherein the at least one processor is further configured to determine a duration of the search window based at least in part on the associated uncertainty value.

Clause 30. The apparatus of clause 26 wherein the at least one processor is further configured to determine a reference signal time difference value based at least in part on the first time and the second time.

Clause 31. The apparatus of clause 26 wherein the assistance data is received from a location management function via one or more LPP messages.

Clause 32. An apparatus, comprising: a memory; at least one transceiver; at least one processor communicatively coupled to the memory and the at least one transceiver, and configured to: receive assistance data including search window subframe offset information; receive a first positioning reference signal at a first time; determine a search window for a second positioning reference signal based at least in part on the first time and the search window subframe offset information; and receive the second positioning reference signal at a second time, wherein the second time is proximate to the search window.

Clause 33. The apparatus of clause 32 wherein the search window subframe offset information is an information element in the assistance data.

Clause 34. The apparatus of clause 32 wherein the assistance data includes an expected reference signal time difference value and an associated uncertainty value.

Clause 35. The apparatus of clause 34 wherein the at least one processor is further configured to determine a duration of the search window based at least in part on the associated uncertainty value.

Clause 36. The apparatus of clause 32 wherein the at least one processor is further configured to determine a reference signal time difference value based at least in part on the first time and the second time.

Clause 37. The apparatus of clause 32 wherein the assistance data is received from a location management function via one or more LPP messages.

Clause 38. The apparatus of clause 32 wherein the assistance data is received via one or more system information blocks.

Clause 39. An apparatus for determining a positioning reference signal search window, comprising: means for receiving assistance data including an integer value associated with signals transmitted from a first station and a second station, wherein the signals include similar timing indications and the integer value represents a nearest time difference between a first timing indication transmitted by the first station and a similar second timing indication transmitted by the second station; means for receiving a first positioning reference signal at a first time, wherein the first positioning reference signal is transmitted by the first station; means for determining a search window for a second positioning reference signal based at least in part on the first time and the integer value; and means for receiving the second positioning reference signal from the second station at a second time, wherein the second time is proximate to the search window.

Clause 40. An apparatus for determining a positioning reference signal search window, comprising: means for receiving assistance data including a subframe offset value associated with signals transmitted from a first station and a second station, wherein the signals are organized into a plurality of subframes in a time domain and the subframe offset value represents a multiple of a half subframe; means for receiving a first positioning reference signal at a first time, wherein the first positioning reference signal is transmitted by the first station; means for determining a search window for a second positioning reference signal based at least in part on the first time and the subframe offset value; and means for receiving the second positioning reference signal from the second station at a second time, wherein the second time is proximate to the search window.

Clause 41. An apparatus for determining a positioning reference signal search window, comprising: means for receiving assistance data including search window subframe offset information; means for receiving a first positioning reference signal at a first time; means for determining a search window for a second positioning reference signal based at least in part on the first time and the search window subframe offset information; and means for receiving the second positioning reference signal at a second time, wherein the second time is proximate to the search window.

Clause 42. A non-transitory processor-readable storage medium comprising processor-readable instructions configured to cause one or more processors to determine a positioning reference signal search window, comprising code for: receiving assistance data including an integer value associated with signals transmitted from a first station and a second station, wherein the signals include similar timing indications and the integer value represents a nearest time difference between a first timing indication transmitted by the first station and a similar second timing indication transmitted by the second station; receiving a first positioning reference signal at a first time, wherein the first positioning reference signal is transmitted by the first station; determining a search window for a second positioning reference signal based at least in part on the first time and the integer value; and receiving the second positioning reference signal from the second station at a second time, wherein the second time is proximate to the search window.

Clause 43. A non-transitory processor-readable storage medium comprising processor-readable instructions configured to cause one or more processors to determine a positioning reference signal search window, comprising code for: receiving assistance data including a subframe offset value associated with signals transmitted from a first station and a second station, wherein the signals are organized into a plurality of subframes in a time domain and the subframe offset value represents a multiple of a half subframe; receiving a first positioning reference signal at a first time, wherein the first positioning reference signal is transmitted by the first station; determining a search window for a second positioning reference signal based at least in part on the first time and the subframe offset value; and receiving the second positioning reference signal from the second station at a second time, wherein the second time is proximate to the search window.

Clause 44. A non-transitory processor-readable storage medium comprising processor-readable instructions configured to cause one or more processors to determine a positioning reference signal search window, comprising code for: receiving assistance data including search window subframe offset information; receiving a first positioning reference signal at a first time; determining a search window for a second positioning reference signal based at least in part on the first time and the search window subframe offset information; and receiving the second positioning reference signal at a second time, wherein the second time is proximate to the search window.

1. A method for determining a positioning reference signal search window, comprising:
receiving assistance data including an integer value associated with signals transmitted from a first station and a second station, wherein the signals include similar timing indications and the integer value represents a nearest time difference between a first timing indication transmitted by the first station and a similar second timing indication transmitted by the second station;
receiving a first positioning reference signal at a first time, wherein the first positioning reference signal is transmitted by the first station;
determining a search window for a second positioning reference signal based at least in part on the first time and the integer value; and
receiving the second positioning reference signal from the second station at a second time, wherein the second time is proximate to the search window.

2. The method of claim 1 wherein the first timing indication and the similar second timing indication are a system subframe number.

3. The method of claim 1 wherein the assistance data includes an expected reference signal time difference value and an associated uncertainty value.

4. The method of claim 3 wherein a duration of the search window is based at least in part on the associated uncertainty value.

5. The method of claim 1 further comprising determining a reference signal time difference value based at least in part on the first time and the second time.

6. The method of claim 1 wherein the assistance data is received from a location management function via one or more LPP messages.

7. A method for determining a positioning reference signal search window, comprising:
receiving assistance data including a subframe offset value associated with signals transmitted from a first station and a second station, wherein the signals are organized into a plurality of subframes in a time domain and the subframe offset value represents a multiple of a half subframe;
receiving a first positioning reference signal at a first time, wherein the first positioning reference signal is transmitted by the first station;
determining a search window for a second positioning reference signal based at least in part on the first time and the subframe offset value; and
receiving the second positioning reference signal from the second station at a second time, wherein the second time is proximate to the search window.

8. The method of claim 7 wherein a location of the search window is based at least in part on a parity the subframe offset value, wherein the parity includes an odd subframe offset value or an even subframe offset value.

9. The method of claim 7 wherein the assistance data includes an expected reference signal time difference value and an associated uncertainty value.

10. The method of claim 9 wherein a duration of the search window is based at least in part on the associated uncertainty value.

11. The method of claim 7 further comprising determining a reference signal time difference value based at least in part on the first time and the second time.

12. The method of claim 7 wherein the assistance data is received from a location management function via one or more LPP messages.

13. A method for determining a positioning reference signal search window, comprising:
receiving assistance data including search window subframe offset information;
receiving a first positioning reference signal at a first time;
determining a search window for a second positioning reference signal based at least in part on the first time and the search window subframe offset information; and
receiving the second positioning reference signal at a second time, wherein the second time is proximate to the search window.

14. The method of claim 13 wherein the search window subframe offset information is an information element in the assistance data.

15. The method of claim 13 wherein the assistance data includes an expected reference signal time difference value and an associated uncertainty value.

16. The method of claim 15 wherein a duration of the search window is based at least in part on the associated uncertainty value.

17. The method of claim 13 further comprising determining a reference signal time difference value based at least in part on the first time and the second time.

18. The method of claim 13 wherein the assistance data is received from a location management function via one or more LPP messages.

19. The method of claim 13 wherein the assistance data is received via one or more system information blocks.

20. An apparatus, comprising:
a memory;
at least one transceiver;
at least one processor communicatively coupled to the memory and the at least one transceiver, and configured to:
receive assistance data including search window subframe offset information;
receive a first positioning reference signal at a first time;
determine a search window for a second positioning reference signal based at least in part on the first time and the search window subframe offset information; and
receive the second positioning reference signal at a second time, wherein the second time is proximate to the search window.

21. The apparatus of claim 20 wherein the search window subframe offset information is an information element in the assistance data.

22. The apparatus of claim 20 wherein the assistance data includes an expected reference signal time difference value and an associated uncertainty value.

23. The apparatus of claim 22 wherein the at least one processor is further configured to determine a duration of the search window based at least in part on the associated uncertainty value.

24. The apparatus of claim 20 wherein the at least one processor is further configured to determine a reference signal time difference value based at least in part on the first time and the second time.

25. The apparatus of claim 20 wherein the assistance data is received from a location management function via one or more LPP messages.

26. The apparatus of claim 20 wherein the assistance data is received via one or more system information blocks.
